(19) United States
(12) Patent Application Publication
(10) Pub. No.: US 2016/0215242 A1
(43) Pub. Date: Jul. 28, 2016

(54) Multi-Compartment Pouch Comprising Cleaning Compositions, Washing Process and Use for Washing and Cleaning of Textiles and Dishes

(71) Applicant: WEYLCHEM WIESBADEN GMBH, Wiesbaden (DE)

(72) Inventors: Johannes HIMMRICH, Eppstein (DE); Hans-Jügen SCHOLZ, Alzenau (DE); Joachim ERBES, Frankfurt (DE); Stefan RIEGELBECK, Frankfurt (DE); Wolfgang WALTHER, Kriftel (DE)

(21) Appl. No.: 15/023,423

(22) PCT Filed: Oct. 6, 2014
(86) PCT No.: PCT/EP2014/002709

§ 371 Date: Mar. 21, 2016

(30) Foreign Application Priority Data
Oct. 7, 2013 (EP) 13004808.5

(51) Int. Cl. C11D 17/04; C11D 1/14; C11D 3/39

(52) U.S. Cl. CPC C11D 17/045; C11D 17/044; C11D 17/043; C11D 3/3907; C11D 1/143

(57) ABSTRACT

Disclosed is a multi-compartment pouch made from a water-soluble film and having at least three compartments, said multi-compartment pouch comprises in a first compartment a liquid detergent composition A, in a second compartment a solid bleaching composition B and in a third component a liquid or solid composition C,
said composition A comprising at least 30% by weight, referring to the total amount of composition A, of a mixture comprising at least one anionic surfactant and at least one nonionic surfactant, and of at least 0.001% by weight, referring to the total amount of composition A, of at least one enzyme, and having a water-content of below 10% by weight, referring to the total amount of composition A and said composition A containing no bleaching agent,
said composition B comprising at least one peroxy compound bleaching agent and at least one washing alkali, and
said composition C comprising at least one bleach activator.

The multi-compartment pouch is in particular characterized by a selected combination of ingredients resulting in an advantageous washing and cleaning action.

### CLAIM FOR PRIORITY

This application is a national phase application of PCT/EP2014/002709 FILED Oct. 6, 2014, which was based on application DE 13004808.5 FILED Oct. 7, 2013. The priorities of PCT/EP2014/002709 and DE 13004808.5 are hereby claimed and their disclosures incorporated herein by reference.

### TECHNICAL FIELD

The invention relates to a multi-compartment pouch comprising a selected combination of ingredients in different compartments as well as a washing process and the use of the multi-compartment pouch for laundry applications, such as for washing and cleaning of textiles, or for dishwashing applications. This pouch is designed that in a first step in the washing and cleaning process a liquid detergent composition A, this is a liquid cleaning agent comprising one or more surfactants and one or more enzymes but no bleach are used and in a second step time-delayed a solid bleaching composition B comprising one or more bleaches and one or more washing alkalis as well as a solid composition C comprising one or more bleaching activators are added.

### BACKGROUND

Liquid detergents are enjoying greatly increasing popularity in the market because their dosage is easy and is possible without dust formation, they rapidly release the washing-active ingredients upon washing and, moreover, they do not leave behind residues on the laundry.

Multi-compartment pouches comprising laundry compositions are known in the prior art.

WO 01/60966 A1 discloses a composition in a water-soluble pouch, wherein the pouch comprises at least two compartments and each compartment comprises another component of the composition and wherein the first compartment comprises a first component comprising a liquid matrix and a peracid. The compositions are used in a washing process.

WO 02/08380 A1 discloses an article comprising a first bag made of water-soluble material which comprises in its interior a) a first solid or liquid composition and b) comprising a second bag made from water-soluble material comprising in its interior a second solid or liquid composition. The article can contain, for example, a composition for cleaning of textiles or for textile care.

EP 2 014 756 A1 discloses a bag for washing applications made from a water-soluble film comprising at least two chambers, wherein the first chamber comprises a liquid component comprising a bleach activator and wherein the second chamber comprises a solid component comprising a peroxide source.

WO 2011/159510 A1 discloses a multi-chamber pouch comprising a first chamber and a second chamber, wherein the first chamber contains a solid composition and wherein the solid composition contains an oxygen bleach source, a bleach activator and a polycarboxylate-polymer and wherein the second chamber comprises a liquid composition and said liquid composition comprises a solvent with low molecular weight.

Multi-chamber pouches with three and even more different compartments are disclosed in the prior art, for example in WO 01/61099 A1, GB 2187748 A, EP 414463 A2, EP 236136 A2, WO 2012/162220 A1, WO 2011/094687 A1, WO 2011/094472 A1, WO 2011/094470 A1 and WO 2010/059483 A1.

WO 2011/094690 A1 discloses a pouch comprising a first sealed compartment containing a first composition, said first sealed compartment comprising at least one wall comprising a water-soluble film of a selected PVOH-mixture. Pouches with three different compartments are disclosed in this document. But there is no disclosure of a three-compartment container comprising liquid detergent composition, bleaching agent and bleach activator in different compartments.

WO 02/042408 A2 and US 2002/0169092 A1 disclose a machine dishwashing product in the form of a water-soluble pouch comprising a plurality of compartments in generally superposed or superposable relationship each of said compartments containing one or more detergent active or auxiliary components and having a volume of from about 5 to about 70 ml and a longitudinal/transverse aspect ratio in the range from about 2:1 to about 1:8. In the examples compositions are disclosed comprising nonionic surfactants but no anionic surfactants. The amount of surfactant is between 0.2% and 30% by weight of the composition.

DE 200 23 763 U1 discloses laundry, cleaning or dishwashing compositions which are incorporated within at least one compartment of a hollow body made from a material which disintegrates under washing, cleaning or dishwashing conditions. The compositions contain surfactants, builders, bleaching getns, bleach activators, enzymes, anti-foaming agents, dyes and perfumes as well as binders or disintegration agents.

EP 2133410 A1 discloses a multi-compartment pouch suitable for use in a laundry application comprising a water-soluble film and having at least a first and a second compartment which contain each a composition and wherein in the second compartment a whitening agent is contained that exhibits a hueing efficiency of at least 5 and a wash removal value in the range of form about 30% to about 95%. In the examples of this document a composition comprising enzymes non-ionic and anionic surfactants and alkaline builders is disclosed. Furthermore a composition is disclosed wherein PAP is separated from the enzyme containing composition.

US 2009/0233830 A1 discloses an automatic dishwashing detergent composition in unit dose form comprising at least about 0.2 mg of active starch degrading enzyme per gram of composition and with a weight of the composition of less than about 25 grams. In this document it is taught to separate bleach and builders from enzymes and to release the enzymes prior to the bleaching composition to allow optimal conditions for the enzymes to operate.

DE 201 06 897 U1 and DE 199 45 849 A1 disclose multi-component washing and cleaning agents wherein bleaching agent and bleach activator are in different phases which are spatially separated.

A major disadvantage of the liquid detergents from the prior art is their low compatibility with bleaching systems and, resulting therefrom, their poor detergency on bleachable soilings, especially when enzyme-sensitive and bleachable soilings are involved. Furthermore, the washing results should be improved, especially when low-temperature washing processes are involved (e.g. washing liquors between 20 and 40° C.).

The object was therefore to provide a composition for washing and cleaning of textiles or for automatic dishwashing by using liquid detergent compositions, which improve the cleaning result considerably, which avoids or at least diminishes the disadvantages of the prior art and is especially characterized by an beneficial wash and cleaning capacity.

### SUMMARY OF INVENTION

Surprisingly it was found that this object can be solved by providing a formulation of selected ingredients in a multi-compartment pouch comprising in the single compartments selected ingredients.

The invention relates to a multi-compartment pouch made from a water-soluble film and having at least three compartments, said multi-compartment pouch comprises in a first compartment a liquid detergent composition A, in a second compartment a solid bleaching composition B and in a third component a liquid or solid composition C,

said composition A comprising at least 30% by weight, referring to the total amount of composition A, of a mixture comprising at least one anionic surfactant and at least one nonionic surfactant, and of at least 0.001% by weight, referring to the total amount of composition A, of at least one enzyme, and having a water-content of below 10% by weight, referring to the total amount of composition A and said composition A containing no bleaching agent,
said composition B comprising at least one peroxy compound bleaching agent and at least one washing alkali, and
said composition C comprising at least one bleach activator.

When using the multi-compartment pouch of the invention an advantageous wash and cleaning capacity is obtained, especially when enzyme-sensitive and bleachable soilings are involved.

The wash and cleaning capacity of a preferred multi-compartment pouch of the invention with time-delayed release of composition B compared with release of composition A is significantly enhanced in comparison with multi-compartment pouches of the invention in which bleaching agents on the one hand and surfactants and enzymes on the other hand are released simultaneously.

The solid and/or liquid compositions can optionally contain also other ingredients which are commonly contained in detergent compositions.

### DETAILED DESCRIPTION

The water-soluble multi-compartment pouch of the present invention (herein referred to as pouch), comprises at least a first, a second and a third compartment. The first compartment comprises a liquid detergent composition A, the second compartment comprises a solid bleaching composition B and the third compartment comprises a liquid or solid composition C. The pouch is typically a closed structure, made of materials described herein, enclosing a volume space. The volume space is separated into at least three compartments.

The pouch can be of any form, shape and material which is suitable to hold the compositions, e.g. without allowing the release of the compositions from the pouch prior to contact of the pouch with water. The exact execution will depend, for example, on the type and amount of the compositions.

In the pouch, the number of compartments is at least three.

Preferably, the water-soluble multi-compartment pouch comprises at least a first compartment, a second compartment and a third compartment in one embodiment, wherein the second compartment comprises a solid bleaching composition B and the third compartment comprises a liquid or solid composition C. Preferably, the solid compositions are selected from the group comprising powder, granule or tablet. Most preferably, the first compartment comprises a liquid detergent composition A which is selected from the group comprising liquid or gel, the second compartment comprises a solid bleaching composition B which is selected from the group comprising powder, granule or tablet and the third compartment comprises a solid composition C which is selected from the group comprising powder, granule or tablet.

In another embodiment, the water-soluble multi-compartment pouch comprises three compartments, wherein the first compartment comprises a liquid detergent composition A and the second compartment comprises a solid bleaching composition B and the third compartment comprises a liquid composition C selected from the group comprising liquid or gel. Preferably, the first compartment comprises a liquid composition and the second and third compartments comprise solid compositions.

In a further embodiment, the water-soluble pouch comprises four compartments, wherein the first compartment comprises a liquid detergent composition A, the second compartment comprises a solid bleaching composition B, the third compartment comprises a liquid or solid composition C and the fourth compartment comprises a composition selected from the group comprising liquid, gel, powder, granule or tablet. Preferably, the first, third and fourth compartments comprise liquid compositions. It is advantageous to have multiple compartments in a single pouch. This allows the combination of incompatible components and components requiring dry or liquid environments.

The single compartments in the pouch are preferably adapted to encompass a unit dose of the ingredients.

The compartments of the pouches can be separate, but are preferably conjoined in any suitable manner. Most preferably the second and third or subsequent compartments are superimposed on the first compartment. In one embodiment, the third compartment may be superimposed on the second compartment, which is in turn superimposed on the first compartment in a sandwich configuration. Alternatively, the second and third compartments are superimposed on the first compartment. However it is also equally envisaged that the first, second and third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment.

In a preferred embodiment the present pouch comprises three compartments consisting of a large first compartment and two smaller compartments. The second and third smaller compartments are superimposed on the first larger compartment. The size and geometry of the compartments are chosen such that this arrangement is achievable.

The term “water-soluble film” or “water-soluble polymer” as used in this specification encompasses films and polymers which disintegrate when in contact with water by forming a solution and/or a dispersion of the polymer in water.

The pouch is preferably made of a film material wherein the film material is soluble in water, and has a water-solubility of at least 50%, preferably at least 75% or even at least 95%, as measured by the method set out here after using a glass-filter with a maximum pore size of 20 microns:

50 grams±0.1 gram of pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved fraction). Then, the percentage solubility can be calculated.

Preferred pouch materials are polymeric materials, preferably polymers which are formed into a film or sheet. The pouch material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols (PVA), polyvinyl pyrrolidone, polyalkylene oxides, acrylamide, acrylic acid, cellulose, cellulose ethers, cellulose esters, cellulose anmides, polyvinyl acetates, polycarboxylic acids and salts, polyaminoacids or peptides, polyamides, polyacrylamide, copolymers of maleic acrylic acids, poly-saccharides including starch and gelatine, natural gum, such as xanthum and carragurn. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. The polymer can have any weight average molecular weight, preferably from about 1000 to 1,000,000 more preferably from about 10,000 to 300,000 yet more preferably from about 20,000 to 150,000.

Mixtures of polymers can also be used as the pouch material. This can be beneficial to control the mechanical and/or dissolution properties of the pouch or compartments of the pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of polyvinylalcohol “PVA” or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and watersoluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Naturally, different film material and/or films of different thickness may be employed in making the compartments of the pouch of the present invention. A benefit in selecting different films is that the resulting compartments may exhibit different solubility or release characteristics.

Most preferred pouch materials are PVA films known under the trade reference MonoSol® M8630, as sold by MonoSol, LLC being a wholly owned subsidiary of Kuraray Holdings, U.S.A. located in Merrillville, Ind., U.S.A., and PVA films of corresponding solubility and deformability characteristics. Other films suitable for use herein include films known under the trade reference PT film or the K-series of Films supplied by Aicello, or VF-HP film supplied by Kuraray.

The pouch material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants.

For reasons of deformability, pouches or pouch compartments containing a component which is liquid will preferably contain an air bubble having a volume of up to about 50%, preferably up to about 40%, more preferably up to about 30%, more preferably up to about 20%, more preferably up to about 10% of the volume space of said compartment.

The pouch of the present invention may be made using any suitable equipment and method. The multi-compartment pouches are made using vertical, but preferably horizontal form filling techniques commonly known in the art. The film is preferably dampened, more preferably heated to increase die malleability thereof. Even more preferably, the method also involves the use of a vacuum to draw the film into a suitable mould. The vacuum drawing the film into the mould can be applied for 0.2 to 5 seconds, preferably 0.3 to 3 or even more preferably 0.5 to 1.5 seconds, once the film is on the horizontal portion of the surface. This vacuum may preferably be such that it provides an under-pressure of between −100 mbar to −1000 mbar, or even from −200 mbar to −600 mbar.

The moulds, in which the pouches are made, ran have any shape, length, width and depth, depending on the required dimensions of the pouches. The moulds can also vary in size and shape from one to another, if desirable. For example, it may be preferred that the volume of the final pouches is between 5 and 300 ml, or even 10 and 150 ml or even 20 and 100 ml and that the mould sizes are adjusted accordingly.

Heat can be applied to the film, in the process commonly known as thermoforming, by any means. For example the film may be heated directly by passing it under a heating element or through hot air, prior to feeding it onto the surface or once on the surface. Alternatively it may be heated indirectly, for example by heating the surface or applying a hot item onto the film. Most preferably the film is heated using an infrared light. The film is preferably heated to a temperature of 50 to 120° C., or even 60 to 90° C.

Alternatively, the film can be wetted by any mean, for example directly by spraying a wetting agent (including water, solutions of the film material or plasticizers for the film material) onto the film, prior to feeding it onto the surface or once on the surface, or indirectly by wetting die surface or by applying a wet item onto the film.

Once a film has been heated and wetted, it is drawn into an appropriate mould, preferably using a vacuum. The filling of the moulded film can be done by any known method for filling (preferably moving) items. The most preferred method will depend on the product form and speed of filling required. Preferably the moulded film is filled by in-line filling techniques. The filled, open pouches are then closed, using a second film, by any suitable method. Preferably, this is also done while in horizontal position and in continuous, constant motion. Preferably the closing is done by continuously feeding a second film, preferably water soluble film, over and onto the open pouches and then preferably sealing the first and second film together, typically in the area between the moulds and thus between the pouches.

Preferred methods of sealing include heat sealing, solvent welding, and solvent or wet sealing. It is preferred that only the area which is to form the seal, is treated with heat or solvent. The heat or solvent can be applied by any method, preferably on the closing material, preferably only on the areas which are to form the seal. If solvent or wet sealing or welding is used, it may be preferred that heat is also applied. Preferred wet or solvent sealing/welding methods include selectively applying solvent onto the area between the moulds, or on the closing material, by for example, spraying or printing this onto these areas, and then applying pressure onto these areas, to form the seal. Sealing rolls and belts as described above (optionally also providing heat) can be used, for example.

The formed pouches can then be cut by a cutting device. Cutting can be done using any known method. It may be preferred that the cutting is also done in continuous manner, and preferably with constant speed and preferably while in horizontal position. The cutting device can, for example, be a sharp item or a hot item, whereby in the latter case, the hot item “burns” through the film/sealing area.

The pouch of the present invention comprises at least three compartments. The different compartments of the multi-compartment pouch may be made together in a side-by-side style and consecutive pouches are not cut. Alternatively, the compartments can be made separately. The manner of manufacturing and filling the multi-compartment pouch of the invention is known to the skilled artisan.

In a preferred embodiment the pouch material which encloses the compartment comprising the liquid detergent composition A is a water soluble material, which releases the liquid detergent composition A within two minutes into the circumfluent water. Most preferred pouch materials are PVA films known under the trade reference MonoSol® M8630, as sold by MonoSol, LLC a wholly owned subsidiary of Kuraray Holdings U.S.A. located in Merrillville, Ind., U.S.A., and PVA films of corresponding solubility and deformability characteristics. Other films suitable for use herein include films known under the trade reference PT film or the K-series of Films supplied by Aicello, or VF-HP film supplied by Kuraray. The pouch material which encloses the compartment comprising the solid bleaching composition B is a material which generally releases solid bleaching composition B between 10 minutes and 45 minutes, preferably between 10 minutes and 35 minutes, most preferably between 15 minutes and 30 minutes into the circumfluent water. Composition C can be contained in a compartment which releases the composition C within two minutes into the circumfluent water or which releases the composition C between 10 minutes and 45 minutes, preferably between 10 minutes and 35 minutes, most preferably between 15 minutes and 30 minutes into the circumfluent water.

Within the context of the present invention, “liquid” compositions according to the invention are understood as meaning all liquid or flowable presentation forms. Within the context of the present invention, liquid or flowable compositions are those which are pourable and have viscosities of from 5 to 60000 mPas, determined at 20° C. The viscosity can be measured using customary standard methods (for example Brookfeld viscometer LVT-II at 20 revolutions/minute and at 20° C.), wherein spindle 2 is used for the viscosity range 5 to <1000 mPas, spindle 3 is used for 1000 to <5000 mPas, spindle 4 is used for 5000 to <10000 mPas and spindle 7 is used for 10000 to 60000 mPas.

Preferably, the liquid compositions A or A and C used in the multi-compartment pouch according to the invention have viscosities of from 100 to 20000 mPas, particularly preferably from 300 to 10000 mPas and especially preferably from 400 to 5000 mPas.

The compositions A or A and C used in the multi-compartment pouch according to the invention can be gel-like or paste-like, they may be present as homogeneous solutions or as suspensions.

Within the context of the present invention, “solid” compositions according to the invention are understood as meaning all presentation forms made of solid material. Solid compositions may contain minor amounts of liquid components that do not alter the “solid” state of said composition. Solid compositions may have different shapes, for example powders, granules, prills or tablets. Solid compositions may comprise one or more solid components and one or more liquid components in minor amounts.

Preferably, the solid compositions B or B and C used in the multi-compartment pouch according to the invention have a content of liquid ingredients of below 20% by weight, referring to the amount of solid composition B or C, particularly preferably of below 10% by weight and especially preferred from 0-8% by weight.

The liquid detergent composition A contains one or more anionic surfactants and one or more nonionic surfactants in high concentration.

Preferably, the one or more anionic surfactants of the liquid detergent composition A are selected from the group consisting of the surfactant classes of the sulfonates, sulfates, carboxylates and phosphates and the counterions of the anionic surfactants of the liquid composition are selected from the group consisting of cations of sodium, potassium, calcium, magnesium, NH₄⁺ and quaternary ammonium ions [HNR¹R²R³]⁺, in which R¹, R² and R³ independently of another are hydrogen, a linear or branched alkyl group with 1 to 22 carbon atoms, a linear or branched, single or multiple unsaturated alkenyl group with 2 to 22 carbon atomes, a linear mono-hydroxyalkyl group with 2 to 10 carbon atoms, preferably a mono-hydroxyethyl- or a mono-hydroxypropyl group, as well as a linear or branched di-hydroxyalkyl group with 3 to 10 carbon atoms.

Particularly preferred are the one or more anionic surfactants of the liquid detergent composition A which are selected from the group consisting of the surfactant classes of the sulfonates, sulfates, carboxylates and phosphates and the counterions of the anionic surfactants of the liquid composition are selected from the group consisting of cations of sodium, potassium, calcium and magnesium.

Preferably preferred the liquid detergent composition A contains one or more secundary paraffinsulfonates. Secondary paraffinsulfonates are surfactants which contain, in statistical distribution, predominantly one SO₃X group in the secondary position on the paraffin hydrocarbon chain and, to a lesser extent, two or more SO₃X groups in the secondary position on the paraffin hydrocarbon chain (X=counterion). The paraffin hydrocarbon chains are predominantly linear and only to a small fraction of 5% by weight or less branched paraffin chains having 8 to 22 carbon atoms. Particular preference is given to secondary paraffinsulfonates having 13 to 17 carbon atoms in the paraffin group.

The presence of secondary paraffinsulfonates allows the preparation of liquid detergent compositions with lower viscosity or in the alternative with higher detergent content as compared to compositions comprising other detergents, e.g. primary alkane- or alkenesulfonates. Therefore, liquid detergent compositions A comprising one or more secondary paraffinsulfonates are especially preferred.

Furthermore, preference is given to primary sulfonates, preferably alkane- or alkenesulfonates, where the alkyl or alkenyl group can either be branched or linear and can be optionally substituted with a hydroxyl group. The preferred primary sulfonates contain linear alkyl or alkenyl chains having 9 to 25 carbon atoms, preferably having 10 to 20 carbon atoms and particularly preferably having 13 to 17 carbon atoms.

Preference is likewise given to olefinsulfonates which are obtained by sulfonation of C₁₂-C₂₄—, preferably C₁₄-C₁₆-α-olefins with sulfur trioxide and subsequent neutralization. As a consequence of the preparation process, these olefinsulfonates can contain relatively small amounts of hydroxyalkanesulfonates and alkanedisulfonates.

Preference is likewise given to alkenyl- or alkylbenzenesulfonates. The alkenyl or alkyl group can be branched or linear and optionally substituted which a hydroxyl group. The preferred alkylbenzenesulfonates contain linear alkyl chains having 9 to 25 carbon atoms and preferably having 10 to 13 carbon atoms.

Preference is likewise given to ester sulfonates of the formula (1)

R¹—CH(SO₃M)-COOR (1),

in which R¹ is a C₈-C₂₀-hydrocarbon radical, preferably alkyl, and R is a C₁-C₆-hydrocarbon radical, preferably alkyl, M is a cation, which forms a water-soluble salt with the ester sulfonate.

Particular preference is given to methyl ester sulfonates, in which R¹ is C₁₀-C₁₆-alkyl and R is methyl.

Preferred sulfates are water-soluble salts of the formula ROSO₃M, in which R is a C₁₀-C₂₄-hydrocarbon radical, preferably an alkyl or hydroxyalkyl radical with C₁₀-C₂₀-alkyl component, particularly preferably a C₁₂-C₁₈ alkyl or hydroxyalkyl radical. M is sodium, potassium, calcium, magnesium or a mixture thereof.

Preferred ether sulfates are water-soluble salts of the linear formula RO(A)ₘSO₃M in which R is an unsubstituted C₁₀-C₂₄-hydrocarbon radical, preferably C₁₄-C₂₄-alkyl radical, or is a C₁₀-C₂₄-hydrocarbon radical substituted by a hydroxyl group, preferably a C₁₀-C₂₄-hydroxyalkyl radical, particularly preferably a C₁₂-C₂₀ alkyl or hydroxyalkyl radical, especially preferably a C₁₂-C₁₈-alkyl or hydroxyalkyl radical. A is an ethoxy (EO) or propoxy (PO) unit, m is a number greater than 0, preferably between 0.5 and 6, particularly preferably between 0.5 and 3 and M is a cation such as e.g. sodium, potassium, calcium, magnesium or a mixture thereof.

Particular preference is given to C₁₂- to C₁₈-fatty alcohol ether sulfates, where the content of EO is 1, 2, 2.5, 3 or 4 mol per 1 mol of the fatty alcohol ether sulfate and in which M is sodium or potassium.

Further preferred anionic surfactants are carboxylates, in particular fatty acid soaps. The soaps can be saturated or unsaturated and can contain various substituents, such as hydroxyl groups or α-sulfonate groups. Preference is given to linear saturated or unsaturated hydrocarbon radicals as hydrophobic fraction having 6 to 30 and preferably 10 to 18 carbon atoms.

Particularly preferred the liquid detergent composition A contains one or more anionic surfactants which are selected from the group consisting of salts of lauric acid, myristic acid, palmitic acid, stearic acid, behenic acid, hydrogenated erucic acid, oleic acid, linoleic acid, linolenic acid and mixtures thereof and the salts of the fatty acids or fatty acid mixtures of natural fats and oils, preferably of coconut oil, soybean oil, rapeseed oil, sunflower oil, canola oil, palm fat oil, palm kernel oil, olive oil and tallow fat.

Preferred are one or more nonionic surfactants of the liquid detergent composition A selected from the group consisting of the surfactant classes of the alkoxylated fatty alcohols, fatty acid amides, alkoxylated fatty acid amides, alkylphenol polyglycol ethers, amine oxides, polyhydroxy fatty acid amides and alkyl polyglycosides.

The alkyl or alkenyl chain of the alkoxylated fatty alcohols can be linear or branched, primary or secondary, and contains in general 8 to 22 carbon atoms.

Particularly preferred the liquid detergent composition A contains one or more nonionic surfactants which are selected from the group consisting of condensation products of C₁₀- to C₂₀-alcohols with 2 to 18 mol of ethylene oxide per 1 mol of alcohol.

The alcohol ethoxylates can have a narrow homolog distribution of the ethylene oxide (“Narrow Range Ethoxylates”) or a broad homolog distribution of the ethylene oxide (“Broad Range Ethoxylates”).

Examples of commercially obtainable nonionic surfactants of this type are Tergitol® 15-S-9 (condensation product of a linear secondary C₁₁-C₁₅-alcohol with 9 mol of ethylene oxide), Tergitol® 24-L-NMW (condensation product of a linear primary C₁₂-C₁₄-alcohol with 6 mol of ethylene oxide for a narrow molecular weight distribution). This product class likewise includes the Genapol® brands from Clariant.

Another group of preferred nonionic surfactants are oxoalcohols comprising ethylene-oxide (EO) and propyleneoxide (PO) groups. Preferred examples from this group are fatty acid alcohols with 12-18 carbon atoms, preferably from 12-15 carbons atoms, comprising EO- and PO-recurring units. One typical example thereof is a C₁₂₋₁₅ oxoalkohol with 5PO and 2EO groups which is available as ®Genapol EP 2552 from Clariant.

Preference is given to fatty acid amides according to formula (2)

R—CO—N(R¹)₂ (2),

in which R is an alkyl group having 7 to 21, preferably 9 to 17, carbon atoms and each radical R¹ is hydrogen, C₁-C₄-alkyl, C₁-C₄-hydroxyalkyl or (C₂H₄O)ₓH, where x varies from 1 to 3.

Preference is given to C₈-C₂₀-amides, -monoethanolamides, -diethanolamides and -isopropanolamides.

Preference is likewise given to polyethylene, polypropylene and polybutylene oxide condensates of alkylphenols. These compounds include the condensation products of alkylphenols with a C₆- to C₂₀-alkyl group, which can either be linear or branched, with alkene oxides. These surfactants are referred to as alkylphenol alkoxylates, e.g. alkylphenol ethoxylates.

Furthermore, preference is given to water-soluble amine oxides of the formula (3)

R(OR²)ₓN(→O)(R¹)₂ (3).

Here, R is an alkyl, hydroxyalkyl or alkylphenol group with a chain length from 8 to 22 carbon atoms, R² is an alkylene or hydroxyalkylene group with 2 to 3 carbon atoms or mixtures thereof, each radical R¹ is an alkyl or hydroxyalkyl group having 1 to 3 carbon atoms or a polyethylene oxide group having 1 to 3 ethylene oxide units and x is a number from 0 to 10.

Preference is likewise given to using polyhydroxy fatty acid amides of the formula (4)

R¹—CO—NR²Z (4),

where R¹—CO— is an aliphatic acyl radical having 6 to 22 carbon atoms, R² is hydrogen, an alkyl or hydroxyalkyl radical having 1 to 4 carbon atoms and Z is a linear or branched polyhydroxyalkyl radical having 3 to 10 carbon atoms and 3 to 10 hydroxyl groups.

Preference is likewise given to alkyl polyglycosides of the formula RO(G)ₓ, where R is a primary straight-chain or methyl-branched, in particular 2-methyl-branched, aliphatic radical having 8 to 22, preferably 12 to 18 carbon atoms, and G is a glucose unit having 5 or 6 carbon atoms, preferably glucose. The degree of oligomerization x, which indicates the distribution of monoglycosides and oligoglycosides, is preferably a number between 1 and 10, particularly preferably x is between 1.2 and 1.4.

A very preferred group of compounds of formula (4) is a polyhydroxy fatty acid amide of formula (4a)

R¹—CO—N(CH₃)(—CH₂—CHOH—CHOH—CHOH—CHOH—CH₂OH) (4a),

wherein R¹—CO is an aliphatic radical having 6 to 22 carbon atoms.

In a further preferred embodiment of the invention, the liquid detergent composition A contains one or more alkanolamines or their salts.

In a still further preferred embodiment of the invention the liquid detergent composition A is devoid of alkanolamines and their salts. This means, for example, that these substances are also not used as counterions of the anionic surfactants.

In preferred embodiments, the liquid detergent composition A comprises an anti-redeposition nonionic surfactant. Ethoxylated alcohols surfactants, preferably essentially free of alkoxy groups other than ethoxy groups, have been found suitable as anti-redeposition surfactants. Preferably the anti-redeposition non-ionic surfactant has a cloud point above wash temperature, i.e. above 20 to 80° C., more preferably above 60° C. Anti-redeposition surfactants seem to emulsify soils, in particular grease soils, preventing re-deposition on the substrates.

“Cloud point”, as used herein, is a well known property of surfactants and mixtures thereof which is the result of the surfactant becoming less soluble with increasing temperature, the temperature at which the appearance of a second phase is observable is referred to as the “cloud point” (See KirkOthmer's Encyclopedia of Chemical Technology, 3rd Ed., Vol. 22, pp. 360-362).

In preferred embodiments, the liquid detergent composition A comprises a mixture of an anti-redeposition surfactant and a low foaming non-ionic surfactant acting as a suds suppressor. In the case in which the anti-redeposition surfactant comprises an ethoxylated alcohol, preferably the ethoxylated alcohol and the suds suppressor are in a weight ratio of at least about 1:1, more preferably about 1.5:1 and even more preferably about 1.8:1. This is preferred from a performance point of view.

Preferred anti-redeposititon surfactants for use herein include both linear and branched alkyl ethoxylated condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be less than about 18, preferably less than about 15 and even more less than 14. Preferably, the surfactant is substantially free of propoxy groups. Commercially available products for use herein include Lutensol® TO series, C13 oxo alcohol ethoxylated, supplied by BASF, especially suitable for use herein being Lutensol® T07.

Amine oxides surfactants are also useful in the present invention as anti-redeposition surfactants include linear and branched compounds having the formula (3) referred to above.

These amine oxide surfactants in particular include C₁₀-C₁₈ alkyl dimethyl amine oxides and C₈-C₁₈ alkoxy ethyl dihydroxyethyl arnine oxides. Examples of such materials include dimethyloctylamine oxide, diethyldecylamine oxide, bis-(2-hydroxyethyl)-dodecylamine oxide, dimethyldodecylamine oxide, dipropyl-tetradecylamine oxide, methylethylhexadecylamine oxide, dodecylamidopropyl dimethylamine oxide, cetyl dimethylamine oxide, stearyl dimethylamine oxide, tallow dimethylarnine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide.

The total concentration of one or more of the anionic surfactants and of one or more of the nonionic surfactants together in the liquid detergent composition A is at least 30% by weight, based on the total weight of the liquid detergent composition A.

In a preferably preferred embodiment of the invention, the liquid detergent composition A comprises the one or more anionic surfactants and the one or more nonionic surfactants in a total concentration of from 30 to 50% by weight, and particularly preferably from 35 to 45% by weight, in each case based an the total weight of the liquid detergent composition A.

In a further preferred embodiment of the invention, the total amount of the one or more anionic surfactants and of the one or more nonionic surfactants in the liquid detergent composition A is at least 50% by weight, and more preferred from 50 to 80% by weight, and particularly preferred from 55 to 75% by weight, in each case based on the total weight of the liquid detergent composition A.

In one aspect of the aforementioned multi-compartment pouch, the first compartment containing the liquid detergent composition A may comprise, based on total liquid detergent composition A weight, from 10 weight % to 45 weight %, preferably from 15 weight % to 40 weight % or most preferred from 20 weight % to 38 weight % of one or more anionic surfactants and from 5 weight % to 35 weight %, preferably from 10 weight % to 32 weight % or most preferred from 15 weight % to 30 weight % of one or more nonionic surfactants, provided the total amount of the anionic surfactants and of the nonionic surfactants in said liquid detergent composition A is at least 30 weight %.

Preferably, the one or more anionic surfactants and the one or more nonionic surfactants are present in the liquid detergent composition A in a weight ratio of anionic surfactants to nonionic surfactants of from 10:1 to 1:10, particularly preferred from 5:1 to 1:5, especially preferred from 3:1 to 1:3 and extraordinarily preferred from 2:1 to 1:2.

Preferably, the liquid detergent composition A contains a higher amount of anionic surfactant than of nonionic surfactant, very preferred a weight ratio of anionic surfactant to nonionic surfactant from 3:1 to 1.2:1.

Enzymes which are present in the liquid detergent composition A can be conventional enzymes. Preferably, the liquid detergent composition A comprises one or more enzymes selected from the group consisting of proteases, amylases, mannases, lipases, endolases, pectinases, cellulases, pullinases, cutinases and peroxidases.

Available proteases are, for example, Liquanase® Ultra 2.0 XL, BLAP®, Opticlean®, Maxacal®, Maxapem®, Esperase®, Savinase®, Purafect®, OxP and/or Duraxym®,

available amylases are, for example, Steinzyme® Plus 12L, Termamyl®, Amylase® LT, Maxamyl®, Duramyl® and/or Pruafect® Ox,
available mannases are, for example, Mannaway 4.0 L,
available lipases are, for example, Lipex® 100 L, Lipolase®, Lipomax®, Lumafast® and/or Lipozym®,
available endolases are, for example, Endolase® 5000L,
available pectinases are, for example, Pectinex 3X L and/or Pectinex Ultra SPL and
available cellulases are, for example, Carezyme 1000 L and/or Celluclast 1.5 L.

Suitable proteases include metalloproteases and serine proteases, including neutral or alkaline microbial serine proteases, such as subtilisins (EC 3.4.21.62). Suitable proteases include those of animal, vegetable or microbial origin. Microbial origin is preferred. Chemically or genetically modified mutants are included. The protease may be a serine protease, preferably an alkaline microbial protease or a chymotrypsin or trypsin-like protease. Examples of neutral or alkaline proteases include:
(a) subtilisins (EC 3.4.21.62), especially those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, DE-A-6022216A1 and DE-A-206022224A1;
(b) trypsin-like or chymotrypsin-like proteases, such as trypsin (e.g., of porcine or bovine origin), the Fusarium protease described in WO 89/06270 and the chymotrypsin proteases derived from Cellumonas described in WO 05/052161 and WO 05/052146; and
(c) metalloproteases, especially those derived from Bacillus amyloliquefaciens described in WO 07/044993A2.

Preferred commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® Novo Nordisk A/S (Denmark), those sold under the tradename Maxatase®, Maxacal®, Maxapem®, Properase®, Purafect®, Purafect Prime®, Purafect Ox®, FN3®, FN4® and Purafect OXP® Genencor International, and those sold under the tradename Opticlean® and Optimase® by Solvay.

Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334).

Preferred amylases include:
(a) the variants described in WO 94/02597, WO 94/18314, WO 96/23874 and WO 97/43424;
(b) the variants described in U.S. Pat. No. 5,856,164, WO 99/23211, WO 96/23873, WO 00/60060 and WO 06/002643;
(c) variants exhibiting at least 90% identity with SEQ ID No. 4 in WO 06/002643, the wild-type enzyme from Bacillus SP722 and variants described in WO 00/60060.

Suitable commercially available alpha-amylases are DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S), BIOAMYLASE-D(G), BIOAMYLASE® L (Biocon India Ltd.), KEMZYM® AT 9000 (Biozym Ges. m.b.H, Austria), RAPIDASE®, PURASTAR®, OPTISIZE HT PLUS® and PURASTAR OXAM® (Genencor International Inc.) and KAM® (KAO, Japan). In one aspect, preferred amylases are NATALASE®, STAINZYME® and STAINZYME PLUS® and mixtures thereof.

The enzyme can be provided either in the form of a low-dusting solid (typically a granule or prill) or as a stabilized liquid or as a protected liquid or encapsulated enzyme. Numerous techniques are described in the art to produce low dusting solid forms of enzymes, including prilling, extrusion, spheronization, drum granulation and fluid bed spray coating and exemplified in U.S. Pat. No. 4,106,991; U.S. Pat. No. 4,242,219; U.S. Pat. No. 4,689,297, U.S. Pat. No. 5,324,649 and U.S. Pat. No. 7,018,821. Liquid enzyme preparations may, for instance, be stabilized by adding a polyol, such as propylene glycol, a sugar or sugar alcohol, lactic acid or boric acid according to established methods. Protected liquid enzymes or encapsulated enzymes may be prepared according to the methods disclosed in U.S. Pat. No. 4,906,396, U.S. Pat. No. 6,221,829, U.S. Pat. No. 6,359,031 and U.S. Pat. No. 6,242,405.

Enzymes may be combined with enzyme stabilizers. Suitable enzyme stabilizers include oligosaccharides, polysaccharides and inorganic divalent metal salts, such as alkaline earth metal salts, especially calcium salts. Chlorides and sulphates are preferred with calcium chloride an especially preferred calcium salt. Examples of suitable oligosaccharides and polysaccharides, such as dextrins, can be found in WO 07/145964 A2. In case of aqueous compositions comprising protease, a reversible protease inhibitor, such as a boron compound, including borate and 4-formyl phenyl boronic acid or a tripeptide aldehyde, can be added to further improve stability.

Preferably, the total composition of the one or more enzyme in the liquid composition A is between 0.001 and 10% by weight, particularly preferred between 0.001 and 4.5% by weight and extraordinarily preferred between 0.01 and 3.5% by weight, in each case based on the total weight of the liquid composition A.

Surprisingly it has been found that the presence of secondary paraffinsulfonates increases the storage stability of enzymes in the liquid detergent composition A.

In an especially preferred embodiment of the invention the liquid detergent composition A comprises secondary paraffinsulfonates in combination with enzymes, preferably with an amylase.

Solid bleaching composition B is contained in solid form in the pouch of the invention. The ingredients of the solid bleaching composition B may have different shapes, for example may be present as powders, granules, prills or tablets. Different ingredients of the solid bleaching composition B may be present in the pouch of the invention in one or more shaped embodiments. Solid bleaching composition B can comprise, for example, a shaped body comprising at least one selected bleaching agent and another shaped body comprising at least one washing alkali. Or solid bleaching composition B can comprise a shaped body comprising a combination of at least one selected bleaching agent and of at least one washing alkali. Preferably the solid bleaching composition B is provided as a granule, prill or tablet comprising at least one selected bleach and at least one washing alkali.

Preferably, the one or more bleaching agents in the solid bleaching composition B is or are used in an amount that the weigh ratio between the surfactants of the liquid detergent composition A to the one ore more bleaching agents is between 100:1 and 1:1, particularly preferred between 50:1 to 2:1, more particularly preferred between 40:1 to 4:1 and most particularly preferred between 30:1 to 5:1.

Bleaching agents are to be understood as meaning compounds which react with bleach activators and in so doing form peroxyacids which bleach more effectively than the bleaches on their own at low temperatures (e.g. <80° C.).

Suitable bleaching agents are inorganic peracids and/or their salts and/or organic peracids and/or their salts.

Preferred bleaching agents are inorganic perhydrate salts, most preferred perborate, percarbonate, perphosphate, persulfate and persilicate salts. The inorganic perhydrate salts are normally alkali metal salts. The inorganic perhydrate salt may be included as the crystalline solid without additional protection. Alternatively, the salt can be coated. Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-A-1,466,799. The weight ratio of the mixed salt coating material to percarbonate lies in the range from 1:200 to 1:4, more preferably from 1:99 to 19, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Another suitable coating material providing in product stability, comprises sodium silicate of SiO₂: Na₂O ratio from 1.8:1 to 3.0:1, preferably 1.8:1 to 2.4:1, and/or sodium metasilicate, preferably applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

In a preferred embodiment of the invention the solid bleaching composition B is in the form of a powder, of granules, of pellets or of a tablet which are surface-coated with compounds selected from the group of fatty acids, fatty acid alcohols, fatty acid esters, fatty acid amides, paraffines, silicone oils, alkylene glycols, poly(meth)acrylates or polyvinyl alcohols or mixtures thereof.

The presence of a surface coating of powders, granules, pellets or tablets of bleaching composition B within a compartment of a multi-compartment pouch made from a water-soluble film allows improved adjustment of the release of the content of said compartment into the washing liquor after contact of said multi-compartment pouch with water.

Very preferred the solid bleaching composition B is coated with a composition comprising a fatty acid selected from the group consisting of saturated fatty acids with 10 to 20 carbon atoms or monounsaturated fatty acids with 12 to 40 carbon atoms, or a fatty acid ester selected from the group of triglycerides comprising fatty acids with 6 to 24 carbon atoms or esters derived from fatty acids with 10 to 30 carbon atoms and from fatty alcohols with 10 to 40 carbon atoms, or a polyethyleneglycol, or a polyvinyl alcohol which is a partially hydrolysed polyvinyl acetate with a percentage of hydrolysation of from 60% to 98%.

In a very preferred embodiment of the invention the solid bleaching composition B is coated with a first layer comprising a compound selected from the group of fatty acids, fatty acid esters or polyalkylene glycols and with a second layer comprising a polyvinyl alcohol.

In another very preferred embodiment of the invention the coated solid bleaching composition B is contained in a compartment formed by a water-soluble polyvinyl alcohol.

A preferred bleaching agent is potassium peroxymonopersulfate as an inorganic perhydrate salt.

A particularly preferred bleaching agent is sodium percarbonate.

Other possible bleaching agents are organic peracids or peracid salts preferably peroxy-carboxylic acids and salts thereof according to the formula

R—CO—O—O⁻X⁺,

where R is an alkyl group, aralkyl group, cycloalkyl group, aryl group or heterocyclic group, preferably a linear or branched, substituted or unsubstituted alkyl group, especially preferably an alkyl group having 6 to 9 carbon atoms, and X⁺ is a suitable counterion, preferably an H⁺, potassium ion or sodium ion.

Preference is given to peroxyhexanoic acid, peroxyheptanoic acid, peroxyoctanoic acid, peroxynonanoic acid, peroxydecanoic acid and salts thereof.

Another group of organic peracids or peracid salts are peroxysulfonic acids and salts thereof, preferably compounds according to the formula

R—SO₂—O—O⁻X⁺,

where R is an alkyl group, aralkyl group, cycloalkyl group, aryl group or heterocyclic group, preferably a linear or branched, substituted or unsubstituted alkyl group, especially preferably an alkyl group having 6 to 9 carbon atoms, and X⁺ is a suitable counterion, preferably H⁺, a potassium ion or sodium ion.

Furthermore preferred organic peracids or salts thereof are peroxophthalic acids and salts thereof, phthaliminoperacids and salts thereof, diperoxycarboxylic acids and salts thereof or peroxysulfuric acids and salts thereof.

Other organic bleaching agents are diacyl and tetraacyl peroxides, especially diperoxy-dodecanedic acid, diperoxytetradecanedioc acid, and diperoxyhexadecanedioc acid. Dibenzoyl peroxide is another preferred organic peroxyacid herein as well as mono- and diperazelaic acid, mono- and diperbrassylic acid, and N-phthaloylaminoperoxicaproic acid.

Preference is given in particular to the organic peracids or salts thereof which are selected from the group consisting of monoperoxyphthalic acid and its salts, N,N-phthalimidoperhexanoic acid (PAP) and its salts, diperazelaic acid and its salts, diperdodecanedioic acid and its salts and monoperoxysulfuric acid and its salts, the salts preferably being selected from the sodium salts and/or potassium salts.

Among inorganic monoperoxysulfuric acid and its salts, preference is given in particular to potassium peroxymonosulfate (available under the trade name Caroat).

In the multi-compartment pouch of the invention the one or the more bleaching agents are present in composition B in solid form.

The multi-compartment pouch of the invention comprises in the third compartment as composition C at least one bleach activator. This is used in combination with the one or more bleaching agents from composition B. Thus, the action of the bleaching agent is carried out in the presence of one or more bleach activators.

Composition C is contained in liquid form or in solid form in the pouch of the invention. The ingredients of composition C may have different shapes, for example may be present as powders, granules, prills or tablets or may be present in liquid or gel form.

The multi-compartment pouch of the invention can comprise—besides in component C—at least one bleach activator in the liquid detergent composition A and/or in the solid bleaching composition B.

Bleach activators are typically organic peracid precursors that enhance the bleaching action in the course of cleaning at temperatures of 80° C. and below, preferably of 60° C. and below. Bleach activators suitable for use herein include preferably compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups.

As bleach activators used in the multi-compartments pouches according to the invention one or more substances selected from the following group can be used: polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccin-imide (NOSI), acylated phenolsulfonates, in particular n-nonanoyloxy- or n-lauroyl-oxybenzenesulfonate (NOBS or LOBS), acylated phenolcarboxylic acids, in particular nonanoyloxy- or decanoyloxybenzoic acid (NOBA or DOBA), carboxylic anhydrides, in particular phthalic anhydride, acylated polyhydric alcohols, in particular triacetin, ethylene glycol diacetate, 2,5-diacetoxy-2,5-dihydrofuran and also triethylacetyl citrate (TEAC), and acylated sorbitol and mannitol, or mixtures thereof (SORMAN), acylated sugar derivatives, in particular pentaacetylglucose (PAG), pentaacetylfructose, tetraacetylxylose and octaacetyllactose, and acetylated, optionally N-alkylated glucamine and gluconolactone, and/or N-acylated lactams, for example N-benzoylcaprolactam. Hydrophilically substituted acylacetals and acyllactams are likewise preferably used, such as N-benzoylcaprolactam and N-acetylcaprolactam. In addition, nitrile derivatives such as n-methylmorpholinium acetonitrile methylsulfate (MMA) or cyanomorpholine (MOR) can be used as bleach activators. Combinations of conventional bleach activators can also be used.

Particularly preferred is the one or more bleach activators selected from the group consisting of tetraacetylethylenediamine, decanoyloxy-benzoic acid, n-nonanoyloxybenzenesulfonate and n-lauroyloxybenzenesulfonate.

Bleach activators are present in a level of from 0.1 to 10%, preferably from 0.5 to 5% by weight of the total amount of compositions A, B and C.

In a preferred embodiment of the multi-compartment pouch of the invention the one or more bleach activators are present in the third compartment of said pouch in an amount that the weight ratio between the one or more bleaching agents and the one or more bleach activators is between 25:1 to 1:1 and particularly preferred between 10:1 to 1.5:1.

In a preferred embodiment of the invention the composition C comprises one or more bleach activators, preferably in an amount of 1-10% by weight, particularly preferred in an amount of 1.5-7% by weight and especially preferred in an amount of 2-6% by weight, each referring to the total amount of compositions A, B and C.

If bleach activators are also present in another compartment they are also used in an amount as if they are contained in composition C. Corresponding amounts are indicated above.

A very preferred embodiment of the invention relates to a multi-compartment pouch wherein the liquid detergent composition A contains at least 30% by, referring to the total amount of said liquid detergent composition A, of a mixture of at least one anionic surfactant and at least one nonionic surfactant, wherein the solid bleaching composition B comprises at least one inorganic peroxyacid bleaching agent and at least one washing alkali, and wherein composition C comprises at least one bleach activator.

Besides the aforementioned anionic and nonionic surfactants and enzymes, further constituents which may be present in the liquid detergent composition A are amphoteric and cationic surfactants, builders, cobuilders, washing alkalis, bleach catalysts, sequestrants, soil release polymers, graying inhibitors, color transfer inhibitors, color fixatives, complexing agents, optical brighteners, softening components, dyes, fragrances, hydrotropes, organic solvents, and/or water.

Besides the aforementioned bleaching agents and washing alkalis, further constituents which may be present in the solid bleaching composition B are bleach catalysts, dyes and/or fragrances.

Besides the aforementioned bleach activators, further constituents which may be present in the composition C are bleach catalysts, dyes, fragrances organic solvents and/or water.

Suitable amphoteric and zwitterionic surfactants are alkylbetaines, alkylamidobetaines, aminopropionates, aminoglycinates or amphoteric imidazolinium compounds according to the formula (5)

R¹—CO—NR⁴—(CH₂)ₙ—N⁺R²R³—CH₂—Z (5),

in which R¹ is C₈-C₂₂-alkyl or -alkenyl, R² is hydrogen or CH₂CO₂M, R³CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation such as alkali metal, alkaline earth metal.

Preferred amphoteric surfactants of this formula are monocarboxylates and dicarboxylates.

Examples thereof are cocoamphocarboxypropionate, cocoamidocarboxypropionic acid, cocoamphocarboxyglycinate (or also referred to cocoamphodiacetate) and cocoamphoacetate.

Further preferred amphoteric surfactants are alkyldimethylbetaines and alkyldipolyethoxybetaines with an alkyl radical having 8 to 22 carbon atoms, which can be linear or branched, preferably having 8 to 18 carbon atoms and particularly preferably having 12 to 18 carbon atoms. These compounds are marketed e.g. by Clariant under the trade name Genagen® LAB.

If the liquid detertergent composition A comprises one or more amphoteric surfactants, these are preferably present therein in an amount of from 0.1-10% by weight and particularly preferably in an amount of from 0.5-5% by weight, based on the total weight of the liquid detergent composition A.

Suitable cationic surfactants are substituted or unsubstituted straight-chain or branched quaternary ammonium salts of the type R¹N(CH₃)₃P^{ρ}X^{σ}, R¹R²N(CH₃)₂^{ρ}X^{σ}, R¹R²R³N(CH₃)^{ρ}X^{σ} or R¹R²R³R⁴N^{ρ}X^{σ}.

The radicals R¹, R², R³ and R⁴ can preferably, independently of one another, be unsubstituted alkyl with a chain length of 8 to 24 carbon atoms, in particular of 10 to 18 carbon atoms, hydroxyalkyl having 1 to 4 carbon atoms, phenyl, C₂- to C₁₈-alkenyl, C₇- to C₂₄-aralkyl, (C₂H₄O)ₓH, where x is from 1 to 3, alkyl radicals containing one or more ester groups, or cyclic quaternary ammonium salts. X is a suitable anion.

Further suitable cationic surfactants are quaternary alkylhydroxyalkylammonium salts according to the formula (6)

R¹R²R³R⁴N⁺X⁻ (6),

where R¹ is a linear or branched, saturated or unsaturated alkyl group having 5 to 22 carbon atoms, preferably 8 to 18 carbon atoms, particularly preferably 8 to 14 carbon atoms, R² is a methyl group, R³ is a methyl group or like R⁴ is a group of the formula -A-(OA)ₙ-OH, where A can be a —C₂H₄— and/or —C₃H₆-group and n can be a number from 0 to 20.

X can be any desired anion, for example chloride, bromide, iodide, fluoride, sulfate, hydrogensulfate, carbonate, hydrogencarbonate, acetate, citrate, phosphate, mono- and dihydrogenphosphate, pyrophosphate, polyphosphate, metaphosphate, nitrate, methylsulfate, phosphonate, methylphosphonate, methanedisulfonate, methylsulfonate, ethanesulfonate or an anion of the formulae R⁶SO₃⁻, R⁷SO₄⁻ or R⁶COO⁻, in which R⁶ and R⁷ are C₂-C₂₀—, preferably C₁₀-C₁₈-alkyl, and R⁷ is additionally also C₁-C₁₈-alkylphenyl.

Quaternary C₈-C₁₀-alkyldimethylhydroxyethylammonium chloride or -methosulfate and quaternary C₁₂-C₁₄-alkyldimethylhydroxyethylammonium chloride or -methosulfate is extraordinarily preferred.

If the liquid detergent composition A comprises one or more cationic surfactants, these are preferably present therein in an amount of from 0.1-15% by weight and particularly preferably in an amount of 0.5-7% by weight, based on the total weight of the liquid detergent composition A.

If the liquid detergent composition A comprises one or more cationic surfactants, the weight ratio of the one or more cationic surfactants to the one or more anionic surfactants is preferably from 1:10 to 1:5.

Further ingredients which may be present in the liquid detergent composition A include inorganic and/or organic builders and cobuilders, so-called builders, in order to reduce the degree of water hardness.

Builders suitable for use herein include builder which forms water-soluble hardness ion complexes (sequestering builder) such as citrates and polyphosphates e.g. sodium tripolyphosphate and sodium tripolyphosphate hexahydrate, potassium tripolyphosphate and mixed sodium and potassium tripolyphosphate salts and builder which forms hardness precipitates (precipitating builder) such as carbonates e.g. sodium carbonate.

These builders can be present in the liquid detergent composition A with weight fractions of from 5 to 80%, referring to the amount of the liquid detergent composition A.

Inorganic builders include, for example, alkali metal, ammonium- and alkanolammonium salts of polyphosphates such as, for example, tripolyphosphates, pyrophosphates and glass-like polymeric metaphosphates, phosphonates, silicates, carbonates including bicarbonates and sesquicarbonates, sulfates and aluminosilicates.

Examples of silicate builders are the alkali metal silicates, in particular those with an SiO₂:Na₂O ratio between 1.6:1 and 3.2:1, and also sheet silicates, for example layered sodium disilicate or sodium sheet silicates, as described in U.S. Pat. No. 4,664,839, available from Clariant under the brand SKS®. SKS-6® is a particularly preferred sheet silicate builder.

Preferred silicates are sodium silicates such as sodium disilicate, sodium metasilicate and crystalline phyllosilicates, or layered silicates.

Aluminosilicate builders are particularly preferred. These are in particular zeolites with the formula Na_{z}[(AlO₂)_{z}(SiO₂)_{y}].xH₂O, in which z and y are integers of at least 6, the ratio of z to y is from 1.0 to 0.5, and x is an integer from 15 to 264.

Suitable ion exchangers based an aluminosilicate are commercially available. These aluminosilicates may be of crystalline or amorphous structure, and can be naturally occurring or else prepared synthetically.

Preferred ion exchangers based an synthetic crystalline aluminosilicates are available under the name Zeolith A, Zeolith P(B) (including those disclosed in EP-A-0 384 070) and Zeolith X.

Suitable organic builders including polycarboxyl compounds, such as, for example, etherpolycarboxylates and oxydisuccinates, as described for example in U.S. Pat. No. 3,128,287 and U.S. Pat. No. 3,635,830. Likewise, reference should be made to “TMS/TDS” builders from U.S. Pat. No. 4,663,071.

Other suitable builders include amino acid based compound or a succinate based compound. The term “succinate based compound” and “succinic acid based compound” are used interchangeably herein.

Preferred examples of amino acid based compounds according to the invention are MGDA (methyl-glycine-diacetic acid, and salts and derivatives thereof) and GLDA (glutamic-N, N-diacetic acid and salts and derivatives thereof). GLDA (salts and derivatives thereof) is especially preferred according to the invention, with the tetrasodium salt thereof being especially preferred. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-30sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alpha-alanine-N,N-diacetic acid (&#945; -ALDA), &#946;—alanine-N,N-diacetic acid (&#946; ALDA), serine-N,N-diacetic acid (SEDA), isoserine-N,N-diacetic acid (ISDA), phenylalanine-N,N-diacetic acid (PHDA), anthranilic acid-N N-diacetic acid (ANDA), sulfanilic acid-N, N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053. A preferred example is tetrasodium immino succinate.

Preferably the amino acid based compound or succinate based compound is present in the liquid detergent composition A in an amount of at least 1 wt %, preferably at least 5 wt %, more preferably at least 15 wt %, and most preferably at least 20 wt %. Preferably these compounds are present in an amount of up to 50 wt %, preferably up to 45 wt %, more preferably up to 40 wt %, and most preferably up to 35 wt %. It is preferred that the composition contains 20% wt or less of phosphorous-containing ingredients, more preferably 10% wt or less, most preferably that they are substantially free of such ingredients and even more preferably they are free of such ingredients.

Other builders include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethyl enedioxy) diacetic acid, maleic acid, diglycolic acid, tartaric acid, tartronic acid and fumaric acid. Polycarboxylates which contain three carboxyl groups include, for example, water-soluble citrate.

Correspondingly, a suitable hydroxycarboxylic acid is, for example, citric acid. Another suitable polycarboxylic acid is the homopolymer of acrylic acid. Other suitable builders are disclosed in WO 95/01416.

Other suitable builders including the ether hydroxypolycarboxylates, copolymers of acrylic acid with maleic anhydride, of maleic anhydride which ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids such as e.g. ethylenediaminetetraacetic acid and nitrilotriacetic acid, and also polycarboxylic acids, such as mellitic acid, succinic acid, oxydisuccinic acid, polymaleic acid, benzene-1,3,5-tricarboxylic acid, carboxymethyloxysuccinic acid, and soluble salts thereof.

Builders based on citrate, e.g. citric acid and its soluble salts, in particular the sodium salt, are preferred polycarboxylic acid builders, which can also be used together with zeolites and/or sheet silicates.

Further suitable builders are the 3,3-dicarboxy-4-oxa-1,6-hexanedioates and the related compounds which are disclosed in U.S. Pat. No. 4,566,984.

Builders based on phosphorus can be used, e.g. various alkali metal phosphates such as, for example, sodium tripolyphosphate, sodium pyrophosphate and sodium orthophosphate. It is likewise possible to use phosphonate builders, such as ethane-1-hydroxy-1,1-diphosphonate and other known phosphonates, as are disclosed for example in U.S. Pat. No. 3,159,581, U.S. Pat. No. 3,213,030, U.S. Pat. No. 3,422,021, U.S. Pat. No. 3,400,148 and U.S. Pat. No. 3,422,137.

The builder is typically present at a level of from 1 to 30%, preferably from 5 to 15% by weight of the liquid detergent composition A. It is also preferred that the ratio of sequestering builder to precipitating builder is from about 10:1 to about 1:1, preferably from about 8:1 to 2:1.

The liquid detergent composition A can comprise washing alkalis which increase the pH of the washing liquor. But in view of the upper pH-value of 9 of the washing liquor after addition of the liquid detergent composition A, the amount of such washing alkalis—if present in said liquid detergent composition A—is limited. But the solid bleaching composition B comprises washing alkalis which increase the pH of the washing liquor to a pH-value of the washing liquor of 9 or higher.

The composition C can also comprise washing alkalis which increase the pH of the washing liquor. But if composition C is released into the water together with the liquid detergent composition A in view of the upper pH-value of 9 of the washing liquor after addition of composition A, the amount of such washing alkalis—if present in composition C—is limited. If composition C is released into the washing liquor together with the solid bleaching composition B at a later time of the washing process higher amounts of such washing alkalis in composition C may be present.

Washing alkalis are typically selected from the group consisting of carbonates, hydrogencarbonates and silicates, in particular alkali metal carbonates, alkali metalhydrogencarbonates and alkali metal silicates, with alkali methyl silicates preferably having a molar ratio of SiO₂/M₂O (M=alkali metal atom) of 1:1 to 2.5:1.

Suitable bleach catalysts are preferably bleach-boosting transition metal salts or complexes of manganese, iron, cobalt, ruthenium, molybdenum, titanium or vanadium.

When using metal salts, preference is given in particular to manganese salts in oxidation states +2 or +3, for example manganese halides, the chlorides being preferred, manganese sulfates, manganese salts of organic acids such as manganese acetates, manganese acetyl acetonates, manganese oxalates, and manganese nitrates.

Furthermore, preference is given to complexes of iron in oxidation states II or III and of manganese in oxidation states II, III, IV or IV, which preferably contain one or more macrocyclic ligand(s) with the donor functions N1, NR, PR, O and/or S.

Preference is given to using ligands which have nitrogen donor functions.

Preference is given to transition metal complexes which contain, as macromolecular ligands, 1,4,7-trimethyl1,4,7-triazacyclononane (Me-TACN), 1,4,7-triazacyclononane (TACN), 1,5,9-trimethyl1.[delta].[theta]-triazacyclododecane (Me-TACD), 2-methyl-1,4,7-trimethyl-1,4,7triazacyclononane (MeMeTACN) and/or 2-methyl-1,4,7-triazacyclononane (Me1TACN) or bridged ligands such as 1,2-bis-(4,7-dimethyl-1,4,7-triazacyclonono-1-yl) ethane. (Me4-DTNE) or derivatives of cyclam or cyclen, such as 1,8-dimethylcyclam, 1,7dimethylcyclen, 1,8-diethylcyclam, 1,7-diethylcyclen, 1,8-dibenzylcyclam and 1,7-dibenzylcyclen, as are described e.g. in EP 0 458 397, EP 0458 398, EP 0 549 272, WO 96/06154, WO 96/06157 or WO 2006/125517, but in addition also manganese complexes as are known from EP 1 445 305, EP 1 520 1910, EP 1 557 457 and WO 2011/095308.

Preferred bleach catalysts for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(M) and related complexes (U.S. Pat. No. 4,810,410).

Bleach catalyst, if included in composition A and/or B and/or C, are typically present in a level of from 0.01 to 10%, preferably from 0.5 to 2% by weight referring to composition A or B or C, respectively.

In case liquid detergent composition A comprises one or more bleach catalysts, these are present therein preferably in an amount of from 0.01 to 2% by weight, based on the total weight of liquid detergent composition A.

Available sequestrants are sodium tripolyphosphate (STPP), ethylenediaminetetracetic acid (EDTA) and salts, nitrilotriacetic acid (NTA), polyacrylate, phosphonate, oxalic acid and salt, citric acid, zeolite, condensed phosphates, carbonates, polycarbonates.

Suitable Soil Release Polymers (SRPs) are polyesters obtainable by polymerization of the components selected from one or more sulfo-group-free aromatic dicarboxylic acids and/or salts thereof, one or more sulfo-group-containing dicarboxylic acids, one or more compounds of the formula R¹O(CHR²CHR³O)ₙH, where R¹ is H, a linear or branched alkyl or alkenyl group having 1 to 22 carbon atoms, preferably C₁-C₄-alkyl and particularly preferably methyl, R² and R³, independently of one another, are hydrogen or an alkyl group having 1 to 4 carbon atoms, preferably hydrogen and/or methyl, and n is an integer from 1 to 100, one or more compounds of the formula H—(OCH₂CH₂)ₘ—SO₃X, where m is an integer from 1 to 100 and X is hydrogen or an alkali metal ion, and one or more crosslinking polyfunctional compounds.

In a preferred embodiment of the invention, the liquid detergent composition A comprises one or more Soil Release Polymers.

If the liquid detergent composition A comprises one or more Soil Release Polymers, these are present therein preferably in an amount of from 0.1 to 10% by weight and particularly preferably in an amount of from 0.2 to 3% by weight, based on the total weight of the liquid detergent composition A.

Suitable graying inhibitors are carboxymethylcellulose, methylcellulose, hydroxylalkylcellulose, methylhydroxyethylcellulose, methylhydroxypropylcellulose, methylcarboxymethylcellulose and polyvinylpyrrolidone.

Color transfer inhibitors are also contemplated, for example polyamine N-oxides such as, for example, poly(4-vinylpyridine N-oxide), e.g. Chromabond S-400, ISP; polyvinylpyrrolidone, e.g. Sokalan® HP 50, BASF and copolymers of N-vinylpyrrolidone with N-vinylimidazole and optionally other monomers.

Preferably the liquid detergent composition A, can also comprise color fixatives, for example color fixatives which are obtained by reacting diethylenetriamine, dicyandiamide and amidosulfuric acid, amines which epichlorohydrin, for example dimethylaminopropylamine and epichlorohydrin or dimethylamine and epichlorhydrin or dicyandiamide, formaldehyde and ammonium chloride, or dicyandiamide, ethylenediamine and formaldehyde or cyanamide with amines and formaldehyde or polyamines which cyanamides and amidosulfuric acid or cyanamides which aldehydes and ammonium salts, but also polyamine N-oxides such as, for example, poly-(4vinylpyridine N-oxide), e.g. Chromabond S-400, ISP; polyvinylpyrrolidone, e.g. Sokalan® HP 50, BASF and copolymers of N-vinylpyrrolidone with N-vinylimidazole and optionally other monomers.

Preferably the liquid detergent composition A can comprise complexing agents, for example aminocarboxylates, such as ethylenediamine tetraacetate, N-hydroxyethylethylenediamine triacetate, nitrilotriacetate, ethylenediamine tetra-propionate, triethylenetetraamine hexaacetate, diethylenetriamine pentaacetate, cyclohexanediamine tetraacetate, phosphonates, for example azacycloheptanedi-phosphonate, Na salt, pyrophosphates, etidronic acid (1-hydroxyethylidene-1,1-diphosphonic acid, 1-hydroxyethane-1,1-diphosphonic acid, acetophosphonic acid) and its salts, aminophosphonates, such as ethylenediamine tetrakis (methylenephosphonat), diethylenetriamine pentakis(methylenephosphonate), am inetrimethylenephosphonic acid, cyclodextrins, and polyfunctionally substituted aromatic complexing agents, such as dihydroxydisulfobenzene or ethylenediamine disuccinates.

Optical brighteners which can be used are cyclic hydrocarbons such as distyrylbenzenes, distyrylbiphenyls, diphenyistilbenes, triazinylaminostilbenes, stilbenyl2H-triazoles, for example stilbenzyl-2H-naphthol-[1,2-d]triazoles and bis(1,2,3-triazol-2-yl)stilbenes, benzoxazoles, for example stilbenylbenzoxazole and bis(benzoxazole), furans, benzofurans and benzimidazoles, for example bis(benzo[b]furan-2-yl)biphenyl and cationic benzimidazoles, 1,3-diphenyl-2-pyrazoline, coumarin, naphthalimides, 1,3,5-2-yl derivatives, methinecyanin and dibenzothiophene 5,5-oxide.

Preference is given to anionic optical brighteners, in particular sulfonated compounds.

Also suitable are triazinylaminostilbenes, distyrylbiphenyls and mixtures thereof, 2-(4-styrylphenyl)-2H-naphtho[1,2-d]triazole, 4,4′-bis-(1,2,3-triazol-2-yl)stilbene, aminocoumarin, 4-methyl-7-ethylaminocoumarin, 1,2-bis(benzimidazol-2-yl)ethylene, 1,3-diphenylpyrazoline, 2,5-bis(benzooxazol-2-yl)thiophene, 2-styryl-naphtho[1,2-d]oxazole, 2-(4-styryl-3-sulfophenyl)-2H-naphtho[1,2-d]triazole and 2-(stilben-4-yl)-2H-naphthol[1,2-d]triazole.

If the liquid detergent composition A comprises one or more optical brighteners, these are present therein preferably in amounts of from 0.001 to 2% by weight, particularly preferably in amounts of from 0.002 to 0.8% by weight and especially preferably in amounts of from 0.003 to 0.4% by weight, based an the total weight of said liquid detergent composition A.

Softening components which can be used are quaternary ammonium salts of the type

R¹R²R³R⁴N⁺X⁻

in which
R¹ C₈-C₂₄ n-oder iso-alkyl, preferably C₁₀-C₁₈ n-alkyl,
R² C₁-C₄-alkyl, preferably methyl,
R³ R¹ or R²,
R⁴ R² or hydroxyethyl or hydroxypropyl or oligomers thereof, and
X⁻ bromide, chloride, iodide, methosulfate, acetate, propionate or lactate.

Examples thereof are distearyldimethylammonium chloride, ditallowalkyldimethylammonium chloride, ditallowalkylmethylhydroxypropylammonium chloride, cetyltrimethylammonium chloride or else the corresponding benyzl derivatives such as, for example, dodecyldimethylbenzylammonium chloride. Cyclic quaternary ammonium salts, such as, for example, alkylmorpholine derivatives can likewise be used.

Moreover, besides the quaternary ammonium compounds, imidazolinium compounds (1) and imidazoline derivatives (2) can be used.

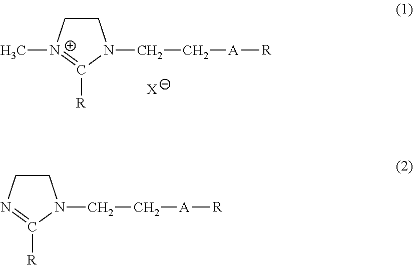

in which
R C₈-C₂₄ n-oder iso-alkyl, preferably C₁₀-C₁₈ n-alkyl,
X bromide, chloride, iodide or methosulfate and

### A —NH—CO—, —CO—NH—, —O—CO— or —CO—O—.

A particularly preferred compound class is the so-called ester quats. These are reaction products of alkanolamines and fatty acids which are then quaternized with customary alkylating agents or hydroxyalkylating agents.

Examples of ester quats are compounds of the formulae:

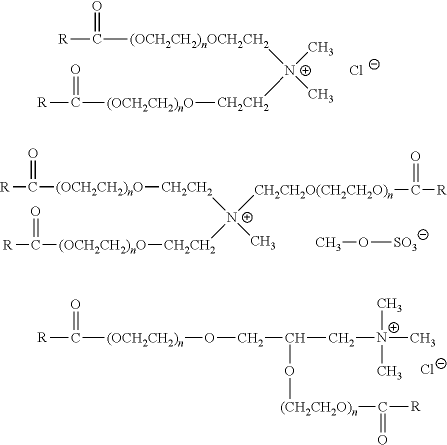

where R—C—O is derived from C₈-C₂₄-fatty acids, which may be saturated or unsaturated. The index n is in the range from 0 to 10, preferably in the range from 0 to 3 and particularly preferably in the range from 0 to 1.

Further preferred fabric softener raw materials are amidoamines based on, for example, trialkyltriamines and long-chain fatty acids, and also their oxethylates and quaternized variants. These compounds have the following structure:

R¹-A-(CH₂)ₙ—N[(CH₂—CH₂—O)ₘ—H]—(CH₂)ₙ-A-R²′

in which
R¹ and R² independently of one another are C₈-C₂₄ n- or iso-alkyl, preferably C₁₀-C₁₈ n-alkyl,

### A —CO—NH— or —NH—CO—,

n 1 to 3, preferably 2, and
m 1 to 5, preferably 2 to 4.

By quaternizing the tertiary amino group, it is possible to additionally introduce a radical R³, which may be C₁-C₄-alkyl, preferably methyl, and a counterion X, which may be chloride, bromide, iodide or methylsulfate. Amidoaminoethoxylates and quaternized subsequent products thereof are supplied under the trade names Varisoft® 510, Varisoft® 512, Rewopal® V 3340 and Rewoquat® W 222 LM.

The liquid detergent composition A preferably comprises dyes and fragrances or perfumes.

In a preferred embodiment of the invention, water-soluble polymer dyes, for example Liquitint®, Liquitint Blue HP®, Liquitint Blue 65®, Liquitint Patent Blue®, Liquitint Royal Blue®, Liquitint Experimental Yellow 8949-43®, Liquitint Green HMC®, Liquitint Yellow 11® and mixtures thereof are used.

Fragrances or perfumes which can be used are individual odorant compounds, e.g. the synthetic products of the ester, ether, aldehyde, ketone, alcohol and hydrocarbon types, Fragrance compounds of the ester type, e.g. benzyl acetate, phenoxyethyl isobutyrate, p-fiert-butylcyclohexyl acetate, linalyl acetate, dimethylbenzylcarbinyl acetate, phenylethyl acetate, linalyl benzoate, benzyl formate, ethylmethylphenyl glycinate, aliylcyclohexyl propionate, styrallyl propionate and benzyl salicylate. The ethers include, for example, benzyl ethyl ether; the aldehydes include e.g. the linear alkanals having 8 to 18 carbon atoms, citral, citronellal, citronellyloxyacetaldehyde, hydroxycitronellal, filial and bourgeonal, the ketones include e.g. the ionons, alpha-isomethylionone and methyl cedryl ketone; the alcohols include anethiol, citronellol, eugenol, geraniol, linalool, phenylethyl alcohol and terpineol; the hydrocarbons include primarily the terpenes and balsams. Preference is given to using mixtures of different odorants which together produce a pleasant scent note.

Perfume oils can also comprise natural odorant mixtures, as are accessible from vegetable or animal sources, e.g. pine oil, citrus oil, jasmine oil, lily oil, rose oil or ylang-ylang oil. Essential oils of relatively low volatility, which are mostly used as aroma components, are also suitable as perfume oils, e.g. sage oil, chamomile oil, clove oil, melissa oil, mint oil, cinnamon leaf oil, linden blossom oil and juniper berry oil.

Preference is given to using solutions or emulsions of the aforementioned fragrances and perfume oils, which can be prepared by customary methods.

Mixtures of compounds from two or more of these substance classes are likewise suitable.

Suitable hydrotropes are xylenesulfonates, toluenesulfonates and cumenesulfonates in the form of their potassium or sodium salts or mixtures thereof.

In a preferred embodiment of the invention, the liquid detergent composition A comprises one or more hydrotropes in an amount of 1-10% by weight, preferably in an amount of 1-6% by weight and particularly preferably in an amount of 2-5% by weight, in each case based an the total weight of the liquid detergent composition A.

Preferred organic solvents originate from the group of mono- or polyhydric alcohols or glycol ethers. Preferably, the solvents are selected from ethanol, n- or isopropanol, butanol, glycol, propane- or butanediol, glycerol, diglycol, propyl or butyl diglycol, hexylene glycol, ethylene glycol methyl ether, ethylene glycol ethyl ether, ethylene glycol propyl ether, etheylene glycol mono-n-butyl ether, diethylene glycol methyl ether, diethylene glycol ethyl ether, propylene glycol methyl, ethyl or propyl ether, dipropylene glycol methyl, or ethyl ether, methoxy-, ethoxy- or butoxytriglycol, 1-butoxyethoxy-2-propanol, 3-methyl-3-methoxybutanol, propylene glycol t-butyl ether, polyglycols, preferably polyethylene glycols, and mixtures of these solvents.

Very preferred organic solvents are ethanol, propanol, 1,2-propanediol and glycerol.

In a preferred embodiment of the invention, the liquid detergent composition A and or the liquid composition C comprises up to 25% by weight of an organic solvent, based on the total weight of the liquid composition A or C.

Furthermore, the composition A and/or B and optionally C, preferably composition A, may comprise low amounts of water.

Furthermore, the compositions A and/or B and/or C, preferably composition A, may comprise low amounts of water.

In a preferred embodiment of the invention, the amount of water in the liquid detergent composition A is <10% by weight, preferably <8% by weight, particularly preferably <6% by weight and especially preferably <5% by weight, in each case based on the total weight of the liquid detergent composition A.

The minimum amount of water here is preferably 2% by weight, based on the total weight of the liquid detergent composition A.

The amount of water in the solid bleaching composition B is <2% by weight, preferably <1% by weight, particularly preferably <0.5% by weight, based on the total weight of the solid bleaching composition B.

In a preferred embodiment of the invention the solid bleaching composition B contains no water or only traces of water, for example 100 ppm by weight or below, based on the total weight of the solid bleaching composition B.

In another preferred embodiment of the invention, the amount of water in composition C is <10% by weight, preferably <8% by weight, particularly preferably <6% by weight and especially preferably <5% by weight, in each case based on the total weight of composition C.

The total water content of the combined liquid detergent composition A and the solid bleaching composition B and the composition C is preferably <10% by weight, based on the total weight of the compositions A and B and C.

The liquid detergent composition A preferably has a pH of 7 to 9, very preferred from 7.5 to 8.5.

However, it is known to the person skilled in the art that the pH of a liquid composition with a water fraction <40% by weight, based on the total weight of the liquid composition, cannot be ascertained for the liquid composition per se. For liquid compositions with a water fraction 10% by weight or less, a 1% strength by weight aqueous solution of the liquid composition is prepared and the pH of this is determined by customary methods.

Consequently, the pH values given above are valid for liquid compositions with a water fraction 10% by weight or less (based on the total weight of the compositions), for a 1% strength by weight aqueous solution of the liquid detergent composition A.

The liquid detergent composition A preferably comprises a combination of components which when said composition A is released from said first compartment into the water contained in the washing machine or in the dishwashing machine form a washing liquor/a dish-washing liquor comprising water and the laundry to be washed and cleaned or the dishes to be cleaned attributes a pH value of between 7 and 9, preferably between 7.5 to 8.5, to said washing liquor or dishwashing liquor.

The solid bleaching composition B comprises a combination of components which when said composition B is released from said second compartment into the washing liquor contained in the washing machine together with the laundry to be washed and cleaned or into the dishwashing liquor contained in the dishwashing machine together with the dishes to be cleaned increase the pH of said washing liquor or of said dishwashing liquor to a value of at least 9, preferably to a value between 9.0 and 10.5, especially preferred between 9.0 and 10.0 and most preferred between 9.0 and 9.5.

Nature and amounts of components of solid bleaching composition B are selected in a manner to result in the pH value of the washing liquor/of the dishwashing liquor referred to above of at least 9. The pH value can be controlled, for example, by the amount of washing alkali present in solid bleaching composition B.

Nature and amounts of components of composition C are preferably selected in a manner to result in the pH value of an 1% strength by weight aqueous solution referred to above of 7 or higher, preferably between 7.0 and 10.5, especially preferred between 7.0 and 9.0 and most preferred between 7.5 and 8.5. The pH is determined by customary methods.

In one embodiment of the invention composition C preferably comprises a combination of components which when said composition C is released from said third compartment together with the liquid detergent composition A contained in the first compartment into the water contained in the washing machine or in the dishwashing machine form a washing liquor or a dishwashing liquor comprising water and the laundry/the dishes to be washed and cleaned attributes together with the liquid detergent composition A a pH value of between 7 and 9, preferably between 7.5 to 8.5, to said washing liquor or to said dishwashing liquor.

In another embodiment of the invention composition C preferably comprises a combination of components which when said composition C is released from said third compartment together with the solid bleaching composition B contained in the second compartment into the washing liquor or into the dishwashing liquor at a later time during the washing process or the dishwashing process attributes together with the solid bleaching composition B a pH value of 9 or higher, increase the pH of said washing liquor or dishwashing liquor to a value of at least 9, preferably between 9.0 and 10.5, especially preferred between 9.0 and 10.0 and most preferred between 9.0 and 9.5 to said washing liquor or to said dishwashing liquor.

The multi-compartment pouch according to the invention can be used advantageously for the washing and cleaning of textiles or for automatic dishwashing and preferably for removing enzyme-sensitive and bleachable soilings on textiles.

At the beginning of the washing process/of the automatic dishwashing process the wash liquor/the dishwashing liquor should have a pH of 7.0 to 9.0, preferably of 7.5 to 8.5. The increase in the pH in the wash liquor/the dishwashing liquor can be achieved by adding washing alkalis, for example sodium carbonate.

During the course of the washing process/of the automatic dishwashing process the pH of the wash liquor/of the dishwashing liquor is increased, for example to a pH of 9.0 to 10.5, preferably of 9.0 to 10.0 and especially preferably of 9.0 to 9.5. The increase in the pH in the wash liquor/in the dishwashing liquor can be achieved by washing alkalis added with composition B and optionally with composition C to said liquor. The addition of composition B and optionally of composition C to the washing liquor/to the dishwashing liquor is performed typically within 15 to 30 minutes after the addition of composition A to the water forming the washing liquor/the dishwashing liquor. In an alternative embodiment compositions A and C are added at the beginning of the washing process to form the washing liquor/the dishwashing liquor and composition B is added at a later time to increase the pH-value of the washing liquor/the dishwashing liquor.

This sequence of steps and timing thereof can be performed by using a selected combination of water-soluble polymers forming the water-soluble pouch and/or by using a selected combination of compartments, for example compartments comprising composition B and composition C, respectively, being housed entirely in compartment comprising composition A. The skilled artisan understands how to provide multi-component pouches with the desired release profile of compositions A, B and C.

The washing temperature/dishwashing temperature is preferably from 20 to 80° C., particularly preferably from 20 to 60° C. and especially preferably from 30 to 60° C.

Preferably, the multi-compartment pouches of the invention are used in automatic washing machines or in automatic dishwashing machines.

A second aspect of the present invention is a method of treating fabrics comprising the steps of:
a) placing fabrics in the drum of a washing machine;
b) adding water and the above-defined multi-compartment pouch to the drum of the fabric washing machine; and
c) treating the fabrics in the washing machine in the washing liquor obtained from the water and the content of the multi-compartment pouch at a temperature between 20 and 80° C., preferably by releasing composition B contained in the multi-compartment pouch after a time between 15 and 30 minutes after forming the washing liquor from the water and composition A contained in the multi-compartment pouch.

A third aspect of the present invention is a method of cleaning dishes comprising the steps of:
d) placing dishes in the interior of an automatic dishwashing machine;
e) adding water and the above-defined multi-compartment pouch to the interior of the automatic dishwashing machine; and
f) treating the dishes in the automatic dishwashing machine in the dishwashing liquor obtained from the water and the content of the multi-compartment pouch at a temperature between 20 and 80° C., preferably by releasing composition B contained in the multi-compartment pouch after a time between 15 and 30 minutes after forming the dishwashing liquor from the water and composition A contained in the multi-compartment pouch.

The fabrics used for washing and cleaning in the process of this invention may be fabrics comprising natural fibers, such as fibers of cotton or of linen, or man-made fibers, such as fibers of rayon, polyester, polyamide or polyacrylnitrile, or combinations of natural fibers with man-made fibers. Preferred cotton fabrics or cotton-polyester mixed fabrics are washed.

The dishes used for washing and cleaning in the process of this invention may be dishes used in household, hospital, laboratory or industry, such as products made from glass, ceramics or metals.

Another aspect of the present invention is the use of the above-defined multi-compartment pouch for washing and cleaning of textiles or for cleaning of dishes.

The examples below are intended to illustrate the invention without limiting it thereto. Unless explicitly stated otherwise, all percentages are to be understood as meaning percentages by weight (% by weight).

### EXAMPLES

Washing experiments were carried out with the following liquid washing formulation in the first compartment, with the bleaching agent in the second compartment and with the bleach activator in the third compartment.

### Example 1

### 1^{st} Compartment

### Liquid Washing Formulation:

| | weight -% |
|---|---|
| Composition | (tel quelle) |
| C₁₂₋₁₅ oxoalkohol, 7 EO-units (water-free) ( ®Genapol | 30.0 |
| OX 070) | |
| C₁₃₋₁₇ secondary alkane sulphonate (contains traces of | 22.0 |
| sodium sulphate and of C₁₃₋₁₇ paraffines) ( ®Hostapur | |
| SAS 93) | |
| 1,2 propanediol | 15.0 |
| potassium hydroxide (as 50% aqueous solution) | 2.0 |
| C₁₂₋₁₈ fatty acid potassium salt | 5.0 |
| glycerol | 9.0 |
| lauryl ether sulphate, 2 EO-units, sodium salt ( ®Genapol | 10.0 |
| LRO Paste) | |
| TexCare ® SRN 170 (active) (nonionic polypropylene | 2.0 |
| terephthalate) | |
| Leucophor ® BSB fl. (optical brightener) | 0.5 |
| Cublen ® BIT 721 (phosphonate) | 2.5 |
| enzyme-mix (Novo) | 2.0 |

A homogeneous mixture was formed from the C₁₂₋₁₅ oxoalkohol, the C₁₃₋₁₇ secondary alkane sulphonate and the 1,2 propanediol and heated to 50° C. Potassium hydroxide aqueous solution and C₁₂₋₁₅ fatty acid potassium salt were added. Thereafter glycerol, lauryl ether sulphate, TexCare® SRN 170, Leucophor® BSB fl. and Cublen® BIT 721 were added one after another and were dissolved in this mixture. Finally the enzyme-mix was added under stirring at room temperature.

The resulting formulation had a water content of about 8%, a pH-value of 7.6-8.0 and a viscosity at 20° C. of about 850 mPas.

dosage: 35 g/washing process

### 2^{nd} Compartment

Solid bleaching agent:
4 g sodium percarbonate
2 g sodium carbonate

### 3^{rd} Compartment

Bleach activator:

### 2 g TAED

Manufacture of the three-compartment pouch consisting of a first compartment housing the liquid washing formulation, of a second compartment housing the bleaching agent and of a third compartment housing the bleach activator TAED.

A pouch prepared from Monosol® M 8630 film of thickness of about 76 μm was filled with 35 g of the liquid washing formulation, example 1, and was closed thereafter. A second pouch prepared from MonoPol® C 100 molded plaque was filled with a solid mixture consisting of 4 g sodium percarbonate and 2 g sodium carbonate and was closed thereafter. A third pouch prepared from Monosol® M 8630 film of thickness of about 76 μm was filled with a 2 g of TAED and was closed thereafter. The three pouches were adhesively attached one to another. In another example a pouch made from Monosol® M 8630 film of thickness of about 76 μm was filled with 35 g of the liquid washing formulation and was closed thereafter. A second pouch made from Monosol® M 8630 film of thickness of about 76 μm was filled with the solid mixture consisting of 4 g sodium percarbonate and 2 g sodium carbonate and was closed thereafter. A third pouch made from Monosol® M 8630 film of thickness of about 76 μm was filled with 2 g TAED and was closed thereafter. The three pouches were adhesively attached one to another.

The washing experiments were carried out under the following conditions:

Washing maschine: Miele Novotronic W 927 WPS

### Program: Boil/Colored

Loading: 3 kg, 2 bed sheets 1.50×1.50 m (ISO 2267),
4 cushions 0.80×0.80 m (ISO 2267),
3 towels, cotton bleached

### Temperature: 40° C.

Wash cycle: 3 times
Amount of water: 12 liters

### Water Hardness: 250 ppm CaCO₃ (14° d)

Test Flannel: 1 fabric sample for each soiling, 15×20 cm

The compartments made from Monosol® M 8630 film of thickness of about 76 μm released the liquid washing formulation, example 1, immediately after addition to the washing liquor.

The compartment made from MonoPol® C100 molded plaque starts to release the ingredients under the above-mentioned washing conditions 22 minutes after addition to the washing liquor.

The differences in reflectance values ΔR 457 nm of washed versus non-washed cotton-textiles or cotton (CO)/polyester (PE) mixed textiles are measured. The measured soiled textiles are commercially available. The following texiles/soilings were measured:

Test-Soilings

| Type | Textile | Soiling | Sensitivity |
|---|---|---|---|
| CFT PC-10 | CO/PE | pigment/oil/milk | Enzyme |
| WFK 10 MF | CO | milk cacao | Enzyme |
| EMPA 116 | CO | blood/milk/ink | Enzyme |
| EMPA 117 | CO/PE | blood/milk/ink | Enzyme |
| EMPA 112 | CO | Cacao | Enzyme |
| EMPA 162 | CO/PE | Starch | Enzyme |
| CFT C-05 | CO | blood/milk/ink | Enzyme |
| CFT CS-01 | CO | blood, aged | Enzyme |
| CFT C-03 | CO | chocolate, milk, carbon black | Enzyme |
| CFT PC-03 | CO/PE | chocolate, milk, carbon black | Enzyme |
| CFT CS-28 | CO | rice starch, colored | Enzyme |
| CFT CS-27 | CO | potato starch | Enzyme |

### Measurement:

### Instrument: Elrepho 3000 (Datacolor)

### Aperture: XLAV Ø 34 mm

### Edge Filter: 400 nm

Table I below shows the differences in reflectance values ΔR 457 nm for 12 enzyme-sensitive soilings listed at

A) concurrent release of the contents of all three compartments made of Monosol® M 8630 film of thickness of about 76 μm into the washing liquor, and
B) retarded release with 22 to 24 minutes time delay of the solid mixture consisting of 4 g sodium percarbonate and 2 g sodium carbonate into the washing liquor.

TABLE I

| | soiling | |
|---|---|---|
| | Difference in reflectance values ΔR 457 nm of | |
| | single enzyme-sensitive soilings | |
| enzyme-sensitive | A) concurrent release | B) time delayed release |
| CFT PC-10 | 30 | 31 |
| WFK 10 MF | 23 | 26 |
| EMPA 116 | 20 | 30 |
| EMPA 117 | 19 | 37 |
| EMPA 112 | 27 | 28 |
| EMPA 162 | 20 | 22 |
| CFT C-05 | 15 | 23 |
| CFT CS-01 | 21 | 24 |
| CFT C-03 | 18 | 18 |
| CFT PC-03 | 36 | 37 |
| CFT CS-28 | 40 | 41 |
| CFT CS-27 | 22 | 24 |

From the results of table I one realizes that a time-delay in the release of the bleaching agent into the washing liquor is beneficial for the cleaning activity against some enzyme-sensitive soilings. Especially for blood/milk/ink on cotton/polyester fabric an improvement of the cleaning activity of 18 reflectance units ΔR 457 nm was obtained when the bleaching agent was released with 22 to 24 minutes delay into the washing liquor compared with parallel dosage of liquid washing formulation and bleaching agent.

Furthermore, the results of table I indicate that the multi-compartment pouches equipped with the ingredients according to the present invention produce beneficial washing results on a variety of textiles carrying a variety of soilings.

### Example 2 and Comparative Example 1

The amounts of ingredients of washing formulation of Example 1 were modified (Example 2) and another washing formulation comprising only nonionic surfactants instead of anionic and nonionic surfactants was provided (Comparative Example 1). The composition of the liquid detergent composition A of Example 2 and of Comparative Example 1 are given in table II.

TABLE II
Composition of liquid formulation containing anionic
and nonionic surfactants (Example 2) and of an adequate
liquid formulation containing the same weight-% of nonionic
surfactants only (Comparative Example 1)

| | | Comparative |
|---|---|---|
| | Example 2 | Example 1 |
| | Weight % | Weight % |
| Ingredient | active | active |
| Hostapur ® SAS 93 | 20.5 | — |
| Genapol OX 070 | 30 | 66.9 |
| Edenor PK 12-18 GA | 8 | — |
| KOH 50% ig | 1 | — |
| Genapol LRO Paste | 8.4 | — |
| Cublen 721 | 2.5 | 2.5 |
| Texcare SRN 170 | 2 | 2 |
| Leucophor BSB liq | 0.5 | 0.5 |
| 1,2 Propandiol | 10 | 10 |
| Ethanol | 2 | 2 |
| Savinase Ultra 16 L | 0.97 | 0.97 |
| Stainzyme plus 12L | 0.48 | 0.48 |
| Mannaway 4.0 L | 0.19 | 0.19 |
| Lipex 100 L | 0.16 | 0.16 |
| Endolase 5000 L | 0.19 | 0.19 |

Three compartment pouches were prepared as described in Example 1.

The washing experiments were carried out under the following conditions:

Washing maschine: Miele Novotronic W 927 WPS

### Program: Boil/Colored

Loading: 3 kg, 2 bed sheets 1.50×1.50 m (ISO 2267),
4 cushions 0.80×0.80 m (ISO 2267),
3 towels, cotton bleached

### Temperature: 40° C.

Wash cycle: 3 times
Amount of water: 12 liters

### Water Hardness: 250 ppm CaCO₃ (14° d)

Test Flannel: 1 fabric sample for each soiling, 15×20 cm

Table III below shows measured differences in reflectance values OR 457 and the sum of the reflectance values of the 3-compartment system consisting of a first compartment of Monosol® M 8630 film comprising 35 g liquid formulation of Example 2 or comprising 35 g liquid formulation of Comparative Example 1, a second compartment made from MonoPol® C102 molded plaque comprising 4 g sodium percarbonate and 2 g sodium carbonate and a third compartment of Monosol® M 8630 film comprising 2 g of tetraacetylethylenediamine.

The second compartment made from MonoPol® C102 molded plaque started to release the ingredients under the below-mentioned washing conditions 15 minutes after addition to the washing liquor.

TABLE III
Differences in reflectance values ΔR 457 and the the sum
of the reflectance values of the 3-compartment system consisting
of a first compartment of Monosol ® M 8630 film
comprising 35 g liquid formulation of Example 2 or of 35
g liquid formulation of Comparative Example 1 and a second
compartment made from MonoPol ® C102 molded plaque
comprising 4 g sodium percarbonate and 2 g sodium carbonate
and a third compartment of Monosol ® M 8630 film
comprising 2 g of tetraacetylethylene diamine

| | | Comparative |
|---|---|---|
| | Example 2 | Example 1 |
| CFT CS-216 lipstick red | 40.6 | 38.4 |
| WFK 10MU make-up | 16.7 | 15.1 |
| CFT CS-3 red wine | 30.4 | 27.3 |
| EMPA 164 grass | 29.9 | 26.3 |
| CFT CS-8 grass | 23.0 | 21.0 |
| WFK 10 K coffee | 37.5 | 37.1 |
| CFT CS-15 blueberry juice | 28.2 | 27.5 |
| CFT PC-10 pigment/oil/milk | 34.1 | 32.5 |
| WFK 10MF milkcacao | 30.3 | 24.8 |
| EMPA 116 blood/milk/ink | 29.6 | 22.3 |
| EMPA 117 blood/milk/ink | 45.8 | 30.9 |
| EMPA 112 cacao | 28.4 | 19.0 |
| EMPA 162 starch | 41.6 | 35.4 |
| CFT C-5 blood/milk/ink | 20.7 | 16.7 |
| CFT C-3 chocolate/milk/carbon black | 27.4 | 21.6 |
| CFT PC-3 chocolate/milk/carbon black | 43.6 | 38.8 |
| CFT CS-28 rice starch, colored | 39.1 | 38.4 |
| CFT CS-27 potato starch, colored | 34.0 | 30.4 |
| Sum | 581 | 503 |

The washing performance of a 3-compartment system comprising the liquid formulation of Example 2 comprising anionic and nonionic surfactants is significantly higher than the washing performance of an adequate 3-compartment system comprising the liquid formulation of Comparative Example 1 comprising only nonoionic surfactants.

### Examples 3 and 4

The following Examples demonstrate the improved viscosity of a liquid formulation comprising C₁₃₋₁₇ secondary alkane sulphonate (SAS) in comparison with a liquid formulation comprising linear alkylbenzene sulfonate (sodium dodecyl-benzene sulfonate, Marlon ARL, LAS)

| | Example 3 | Example 4 |
|---|---|---|
| | weight-%, | weight-%, |
| | active | active |
| Hostapur ® SAS 93 | 20.5 | — |
| UkS, Marlon ARL, 80% | — | 20.5 |
| Genapol OX 070 | 30 | 30 |
| Edenor PK 12-18 GA | 8 | 8 |
| KOH 50% ig | 1 | 1 |
| Genapol LRO Paste | 8.4 | 8.4 |
| Cublen 721 | 2.5 | 2.5 |
| Texcare SRN 170 | 2 | 2 |
| Leucophor BSB liq | 0.5 | 0.5 |
| 1,2 Propandiol | 10 | 10 |
| Ethanol | 2 | 2 |
| Savinase Ultra 16 L | 0.97 | 0.97 |
| Stainzyme plus 12L | 0.48 | 0.48 |
| Mannaway 4.0 L | 0.19 | 0.19 |
| Lipex 100 L | 0.16 | 0.16 |
| Endolase 5000 L | 0.19 | 0.19 |

Viscosity data (Brookfield)

| Liquid formulation | 20° C. | 40° C. |
|---|---|---|
| Example 7 with SAS | 206 mPas | 75.0 mPas |
| Example 8, with LAS | 248 mPas | 88.5 mPas |
| Brookfield details | Spindle 2 | Spindle 1 |

1. A multi-compartment pouch made from a water-soluble film and having at least three compartments, said multi-compartment pouch comprises in a first compartment a liquid detergent composition A, in a second compartment a solid bleaching composition B and in a third component a liquid or solid composition C,
said composition A comprising at least 30% by weight, referring to the total amount of composition A, of a mixture comprising at least one anionic surfactant and at least one nonionic surfactant, and of at least 0.001% by weight, referring to the total amount of composition A, of at least one enzyme, and having a water-content of below 10% by weight, referring to the total amount of composition A and said composition A containing no bleaching agent,
said composition B comprising at least one peroxy compound bleaching agent and at least one washing alkali, and
said composition C comprising at least one bleach activator.

2. A multi-compartment pouch according to claim 1, wherein said pouch is designed to release the liquid detergent composition A housed in the first compartment within two minutes after said pouch is contacted with a liquor comprising water and the laundry to be washed or the dishes to be cleaned of temperature between 20 and 80° C., to release the solid bleaching composition B housed in the second compartment within fifteen to thirty minutes after said pouch is contacted with the liquor comprising water and the laundry to be washed or the dishes to be cleaned of temperature between 20 and 80° C. and to release composition C housed in the third compartment to the liquor either during the release of composition A or during the release of composition B.

3. A multi-compartment pouch according to claim 2, wherein said pouch comprises three compartments.

4. A multi-compartment pouch according to one of claims 1 to 3, wherein the liquid detergent composition A contains one or more secondary paraffinsulfonates.

5. A multi-compartment pouch according to one of the claims 1 to 4, wherein the liquid detergent composition A is devoid of alkanolamines and their salts.

6. A multi-compartment pouch according to one of the claims 1 to 5, wherein the liquid detergent composition A comprises the one or more anionic surfactants and the one or more nonionic surfactants in a total concentration of from 30 to 50% by weight, and particularly preferably from 35 to 45% by weight, in each case based an the total weight of the liquid detergent composition A.

7. A multi-compartment pouch according to one of the claims 1 to 5, wherein the total composition of the one or more anionic surfactants and of the one or more nonionic surfactants in the liquid detergent composition A is at least 50% by weight, and more preferred from 50 to 80% by weight, and particularly preferred from 55 to 75% by weight, in each case based on the total weight of the liquid detergent composition A.

8. A multi-compartment pouch according to one of the claims 1 to 7, wherein the liquid detergent composition A contains a higher amount of anionic surfactant than of nonionic surfactant, very preferred a weight ratio of anionic surfactant to nonionic surfactant from 3:1 to 1.2:1.

9. A multi-compartment pouch according to one of the claims 1 to 8, wherein the liquid detergent composition A comprises one or more enzymes selected from the group consisting of proteases, amylases, mannases, lipases, endolases, pectinases, cellulases, pullinases, cutinases and peroxidases.

10. A multi-compartment pouch according to one of the claims 1 to 9, wherein the one or more bleaching agents in composition B is or are present in an amount that the weigh ratio between the total amount of the surfactants of the liquid detergent composition A to the one or more bleaching agents of the solid composition B is between 100:1 and 1:1, particularly preferred between 50:1 to 2:1, more particularly preferred between 40:1 to 4:1 and most particularly preferred between 30:1 to 5:1.

11. A multi-compartment pouch according to one of the claims 1 to 10, wherein the solid bleaching composition B is in the form of a powder, of granules, of pellets or of a tablet which are surface-coated with compounds selected from the group of fatty acids, fatty acid alcohols, fatty acid esters, fatty acid amides, paraffines, silicone oils, alkylene glycols, poly(meth)acrylates or polyvinyl alcohols or mixtures thereof.

12. A multi-compartment pouch according to claim 11, wherein the solid bleaching to composition B is contained in a compartment formed by a water-soluble polyvinyl alcohol.

13. A multi-compartment pouch according to one of the claims 1 to 12, wherein the bleaching agent in composition B is sodium percarbonate.

14. A multi-compartment pouch according to one of the claims 1 to 13, wherein the at least one washing alkali in composition B is selected from the group consisting of carbonates, hydrogencarbonates and silicates, in particular alkali metal carbonates, alkali metalhydrogencarbonates and alkali metal silicates, preferably alkali metal silicates with a molar ratio of SiO₂/M₂O (M=alkali metal atom) of 1:1 to 2.5:1.

15. A multi-compartment pouch according to one of the claims 1 to 14, wherein the one or more bleach activators in composition C is selected from the group consisting of tetra-acetylethylene-diamine, decanoyloxy-benzoic acid, n-nonanoyloxybenzenesulfonate and n-lauroyloxybenzenesulfonate.

16. A multi-compartment pouch according to one of the claims 1 to 15, wherein composition A contains at least 30% by, referring to the total amount of composition A, of a mixture of at least one anionic surfactant and at least one nonionic surfactant, wherein composition B comprises at least one inorganic peroxyacid bleaching agent and at least one washing alkali, and wherein composition C comprises at least one bleach activator.

17. Method of treating fabrics comprising the steps of:
a) placing fabrics in the drum of a washing machine;
b) adding water and the multi-compartment pouch according to one of claims 1 to 16 to the drum of the fabric washing machine; and
c) treating the fabrics in the washing machine in the washing liquor obtained from the water and the content of the multi-compartment pouch at a temperature between 20 and 80° C.

18. Method of cleaning dishes comprising the steps of:
d) placing dishes in the interior of an automatic dishwashing machine;
e) adding water and the multi-compartment pouch according to one of claims 1 to 16 to the interior of the automatic dishwashing machine; and
f) treating the dishes in the automatic dishwashing machine in the dishwashing liquor obtained from the water and the content of the multi-compartment pouch at a temperature between 20 and 80° C., preferably by releasing composition B contained in the multi-compartment pouch after a time between 15 and 30 minutes after forming the dishwashing liquor from the water and composition A contained in the multi-compartment pouch.

19. Method according to claim 17 or 18, wherein composition B contained in the multi-compartment pouch is released after a time between 15 and 30 minutes after forming the liquor from the water and compositions A and C contained in the multi-compartment pouch.

20. Method according to claim 17 or 18, wherein composition B and composition C contained in the multi-compartment pouch are released after a time between 15 and 30 minutes after forming the liquor from the water and composition A contained in the multi-compartment pouch.

21. Method according to one of the claims 17 to 20, wherein the pH of the washing liquor or of the dishwashing liquor is increased during the course of the washing process or of the dishwashing process to a pH of 9.0 to 10.5.

22. Use of the multi-compartment pouch according to one of the claims 1 to 16 for washing and cleaning of textiles or for cleaning of dishes.
